(19) United States
(12) Patent Application Publication
(10) Pub. No.: US 2013/0159203 A1
(43) Pub. Date: Jun. 20, 2013

(54) Personnel Management

(71) Applicants: Mark Lawrence Munzer, Westwood, MA (US); Elvis Aung Tam, Walpole, MA (US); Andrei Zharau, Lexington, MA (US)

(72) Inventors: Mark Lawrence Munzer, Westwood, MA (US); Elvis Aung Tam, Walpole, MA (US); Andrei Zharau, Lexington, MA (US)

(73) Assignee: PEOPLEFLUENT HOLDINGS CORP., Waltham, MA (US)

(21) Appl. No.: 13/531,520

(22) Filed: Jun. 23, 2012

Related U.S. Application Data
(60) Provisional application No. 61/501,009, filed on Jun. 24, 2011.

(51) Int. Cl. G06Q 10/10

(52) U.S. Cl. CPC G06Q 10/105; G06Q 10/1053
USPC 705/321; 705/320

(57) ABSTRACT

Among other things, in a user interface of an employee management application, a cloud is displayed of thumbnail images of personnel of an organization, e.g. employees, who are associated with respective values of a quantifiable management parameter. The thumbnail images and other graphical features indicate useful information to the personnel manager, for example in the relative sizes of the graphical features that correspond to respective values of the quantifiable management parameter with which they are respectively associated.

### RELATED APPLICATIONS

This application claims the benefit of and claims priority to U.S. Provisional Application 61/501,009, entitled “Employee Management,” filed on Jun. 24, 2011, which is hereby incorporated by reference. This application also incorporates by reference the disclosure of U.S. patent application Ser. No. 11/541,930, filed on Oct. 2, 2006, and related applications.

### TECHNICAL FIELD

This disclosure relates to management of members of an organization, including in managing their records and other information regarding aspects of their status and performance in the organization. Specifically, aspects hereof are directed to mobile applications for management of the information, databases and other functions and information relating to persons who are members of an organization. Some specific examples relate to employee management and tracking in an organization having a plurality of employees.

### BACKGROUND

Personnel management enhanced the effectiveness of an organization, especially one with numerous personnel employed to perform various functions within the organization, who are variably recruited, compensated, tracked and evaluated. A large organization often includes one or more persons who are charged with personnel or employee management. The personnel manager can be a dedicated manager at the organization whose job is to manage the personnel of the organization generally and as a whole. In other situations, personnel management is performed locally within branch offices or within operating units of the organization by the head of a branch or unit. A person who manages other people in a business, for example, is typically charged with a variety of human resource tasks. To aid the manager, software has been made for handling personnel management tasks. To perform one or more of these tasks, the manager may invoke the software processes of a software application running on his workstation. The software application may also enable the manager to view the organizational chart in various display styles. These may include performance reviews, goals setting, salary and bonus allocations, filling open positions, training assignments, and succession planning, for the people who are positioned below the manager in the organizational chart of the business.

However, such software remains cumbersome and inflexible for many purposes, and is not portable for use by managers who move between locations and require convenient access in an intuitive way to their personnel management tools.

### SUMMARY

In general, in an aspect, in a user interface of an employee management application, a cloud is displayed of thumbnail images of employees who are associated with respective values of a quantifiable management parameter. The thumbnail images have relative sizes that correspond to the respective values of the quantifiable management parameter with which they are respectively associated. The present concepts are extendable to management of individuals and groups in almost any organizational setting. For example, not only employees of a company, but faculty or students of a school or university, members of the armed services and its units, members of a political party, a civil organization, and so on.

Implementations may include one or more of the following features. The quantifiable management parameter includes monetary value associated with the employees. The quantifiable management parameter includes a budget value associated with the employees. The quantifiable management parameter includes a percentage of a budget value that has been spent. The user interface is provided on a mobile device. The user interface is provided on a tablet computer.

In general, in an aspect, in a user interface, a cloud of thumbnail images is displayed that is associated with respective values of a quantifiable parameter. The thumbnail images have relative sizes that correspond to the respective values of the quantifiable parameter with which they are associated.

In general, in an aspect, in a user interface, a set of thumbnail images is displayed of employees who are being managed by a user of the user interface. The user is enabled to control, through a feature of the user interface, the employees whose thumbnail images are included in the set, by selecting at least one filtering criterion that is related to an aspect of managing the employees.

Implementations may include one or more of the following features. The names of the employees are also displayed in association with their thumbnail images. The filtering criterion includes at least one of a location, a type of employment, a potential, a performance rating, a flight risk, a position in an organizational structure, and a loss impact. More than one filtering criteria can be selected and deselected at a given time and in succession. The user interface is presented to the user on a display of a mobile device. The user interface is presented to the user on a display of a tablet computer.

In general, in an aspect, in a user interface, a visual navigational tool is provided to enable a user to navigate through a set of candidates for employment to locate particular candidates, one after another. Automatically and simultaneously, as each of the particular candidates is located, a folder is displayed of information concerning the candidate.

Implementations may include one or more of the following features. The visual navigational tool includes images of stacks of folders associated with the candidates, and the user is enabled to navigate through the stacks and from stack of stack by gestural actions on a surface of a screen on which the user interface is presented. The gestural actions include at least one of dragging, touching, and swiping. The user interface is presented to the user on a mobile device. The user interface is presented to the user on a screen of a tablet computer.

In general, in an aspect, in a user interface, a geographical map is displayed showing locations at which employees of an enterprise who are being managed by a user are stationed. The user is enabled to indicate information about the employees to be presented to the user in connection with the geographical map.

Implementations may include one or more of the following features. Each of the locations is identified by a disk on the geographical map. Each of the discs bears an indicator of a number of the employees at that location. The user is enabled to interactively identify filtering criteria that determine the information to be presented. The filtering criteria include at least one of employment status, a potential, a performance rating, a flight risk, a position in an organizational structure, and a loss impact. Each of the discs has a size corresponding to a numerical measure associated with the employees at the corresponding location.

In general, in an aspect, in a user interface, an instructional coaching assistant is provided to a manager of employees and instructional coaching assistant.

In general, in an aspect, on a mobile device, an interactive application is provided that enables a manager of employees to navigate information about the employees. The information that is to be navigated is automatically altered based on a current location of the manager relative to locations at which the employees are stationed.

Implementations may include one or more of the following features. The mobile device includes a tablet computer or a smart phone. The information about the employees includes thumbnail images. The information about the employees includes performance and cost information.

In general, in an aspect, through a user interface of a mobile device, a manager is enabled to navigate information about employees that he is managing. The information is updated in real time as the manager is navigating, at times when the mobile device can wirelessly communicate with a central server. A body of the information is maintained on the mobile device that is sufficient for the manager to navigate when the mobile device cannot wirelessly communicate with the central server. The body of information is updated when the mobile device can wirelessly communicate with the central server.

In general, in an aspect, a mobile electronic device includes a touch-sensitive screen display, an element that enables the device to determine its geographical location, a wireless communication capability, an operating system, and an application. The application is configured to enable a manager of employees to navigate information about the employees, the information being determined at least in part automatically by a current geographical location determined by the element. The information is synchronized automatically with a body of information at a central server so that, when the wireless communication capability is not available, the manager is able to navigate information about the employees on the mobile electronic device.

Other aspects of the invention may include other combinations of one or more of the aspects and features recited above and other aspects and features, expressed as methods, apparatus, systems, and program products, and in other ways, as will become apparent from the following description and from the claims.

### BRIEF DESCRIPTION OF THE DRAWINGS

A preferred embodiment of the invention will now be described by way of specific example with reference to the accompanying drawings, in which:

FIGS. 1 through 33 illustrate exemplary user interface outputs according to some embodiments.

FIG. 34 illustrates a block diagram of a system for personnel management.

### DETAILED DESCRIPTION

In some examples, some of the features of a personnel management system and method can be implemented on a portable device such as a mobile tablet device. In some instances, the mobile device may have wireless communication capability as known to those skilled in the art, and may communicate wirelessly with a base station or wireless LAN device or cellular infrastructure, e.g., according to 802.11 WiFi, cellular, or other wireless communication protocol. In yet further respects, the mobile device on which the present software is implemented can include an iPad® or similar computing tablet by Apple Computer, Cupertino, Calif., USA. A platform such as a computing tablet or similar mobile platform having a user interface executes computer readable instructions in a processing circuit (e.g., a central processing unit CPU, a general processing unit GPU, etc.) and provides hardware, software, and communication features as needed that can be used in providing personnel management features to a manager. For example, a touch screen interface on such devices enables easy navigation. The use of icons to display available actions can be more comprehensive and robust than on desktop computers. In some examples, the personnel management features can be implemented on other kinds of handheld devices, such as mobile phones that include sufficient computing resources to carry out the present processes.

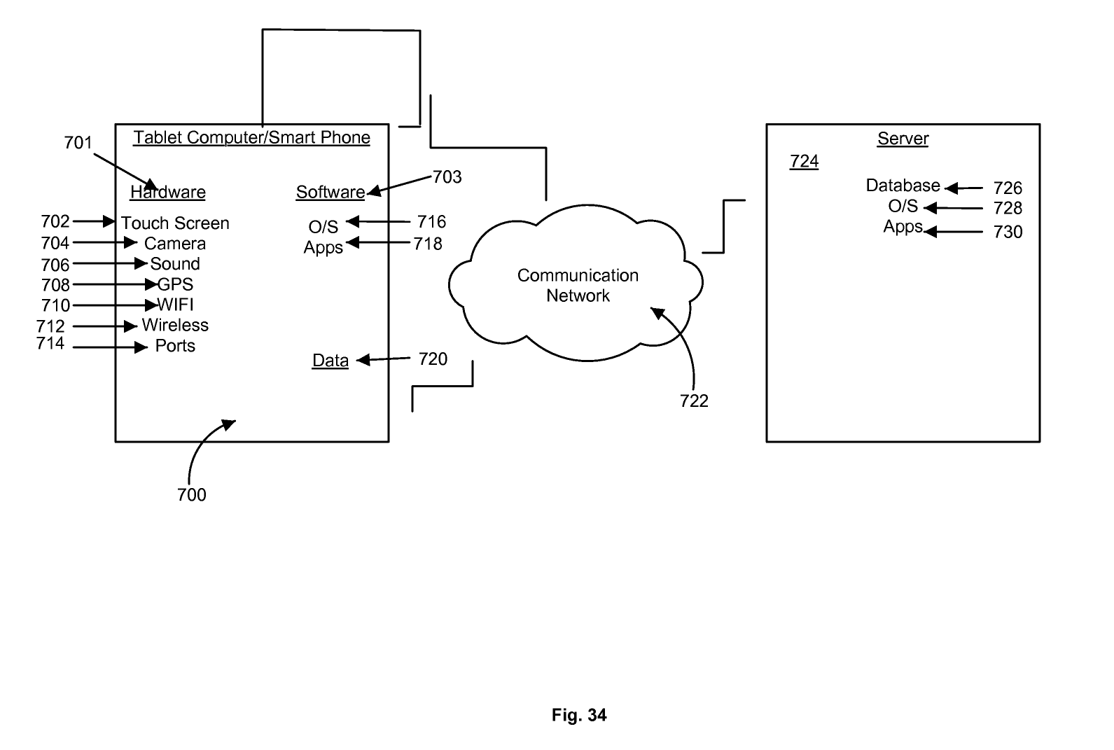

As shown in FIG. 34, a typical tablet computer or smart phone 700 (one of many as shown in the figure) may include hardware elements 701 and software elements 703. The hardware elements can include a touch screen 702, the camera 704, sound devices 706, a GPS or other geographical location device 708, WiFi capability 710, wireless capability 712, and various ports 714. In addition, a wide range and quantity of data 720 can be stored temporarily or permanently and updated and synchronized with other devices. Using its WiFi or wireless communication capability, the tablet computer or smart phone can interact with other devices, computers, machines, databases and as well as a central server 724 through a communication network 722. The communication network may be or may include a local area network (LAN) or a wide area network (WAN) or the Internet as understood by those skilled in the art.

The central server 724 can include an operating system 728, applications 730, and a database 726. The database 726 can store a wide variety of information about employees of an enterprise and may be implemented locally to the server 724 or remotely from it through an appropriate connection. In some embodiments, portions or all of the database 726 can be downloaded and stored on the tablet computer or smart phone, can be updated from time to time, can receive information uploaded from the tablet computer or smart phone, and can synchronize data between the server and the tablet computer or smart phone.

Sometimes, when a user (such as manager of other personnel) is moving from location to location, he or she may wish to have access to and interact with the tablet computer or smart phone, and particularly with specific subsets of data from the database that relate to the manager's current location. For example, if the manager has just landed at an airport in San Diego and turns on his or her tablet computer and launches the personnel management applications, the mobile device (using its GPS or other geographical location feature) may determine that the device (and manager) is visiting the San Diego location.

When the personnel management applications open, they may present screen and information that relate specifically to personnel that the manager manages in San Diego. Later in the week, if he or she arrives in New York City, the application can automatically be configured to present screens of information that relate to personnel that he or she manages in New York, and so on.

Although frequently the availability of WiFi or wireless connections to the central server permit the manager's actions on the user interface to be transmitted to and responded to from the central server, at other times, the manager may be in a location where a communication network is not available. Portion of the database at the central server can be replicated and synchronized on the mobile computing device so that when the manager is outside of communication network range, he or she can still work with personnel data on the mobile computing device. Later, when a communication network is available, synchronization of data can be initiated and completed.

A variety of personnel management applications are possible and can be installed and run on mobile computing platforms, for example, to manage employees of an organization that employees a plurality (or a multitude) of employees.

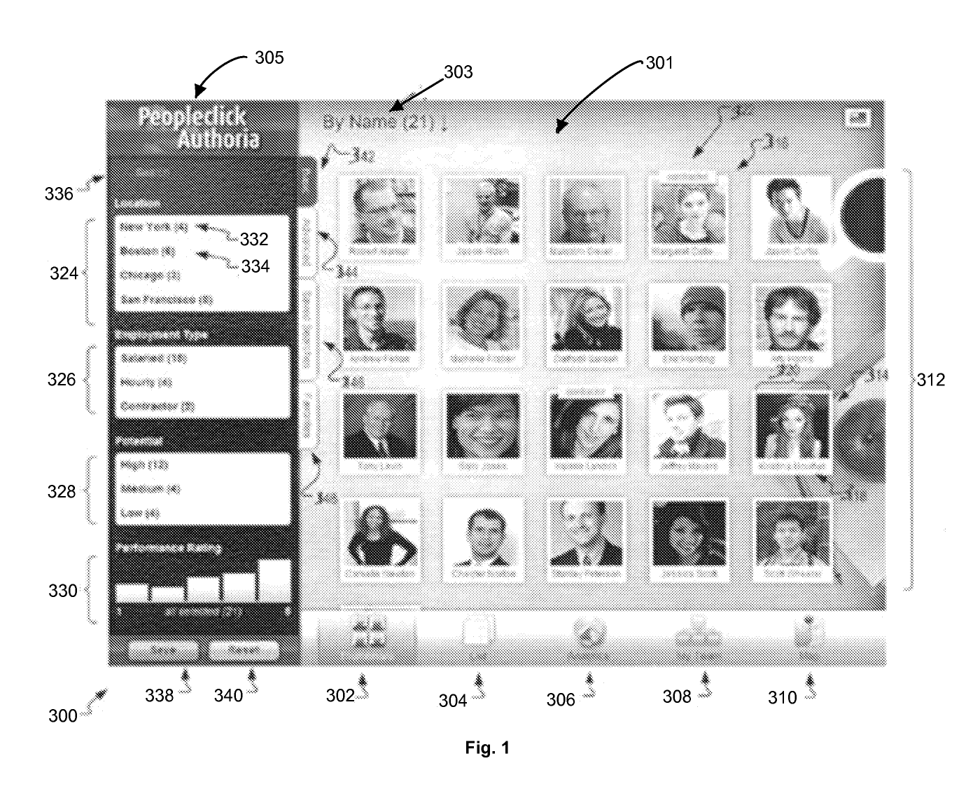

FIG. 1 illustrates an exemplary mobile computing device user interface 300 that displays employee data stored in an employee database, and summaries, aggregations, and analysis of the data. For example, the employee database may contain information about employees of a company, a division, or other organization.

As an illustrative example, the right side of the screen shot of FIG. 1 shows an employee display panel 301 that displays information about multiple employees. In some embodiments, the multiple employee information is displayed to the manager user of the device and software at the same time (simultaneously). The user interface 300 presents employee data in the employee display panel 301 in any one of multiple selectable views that can be easily chosen by touching the appropriate icon, including a thumbnail view (button 302), a list view (button 304), an analytics view (button 306), a team view (button 308), and a map view (button 310). Note that those skilled in the art would appreciate that the present exemplary details of the user interface 300 can be modified and generalized to different user interface elements as available in a given platform. Each view presents employee data in the employee display panel in a different arrangement. The user interface 300 (including the screen shown on FIG. 1 and all of the other screens shown in the other figures) is usable by a human operator or user of the computing device. For example, the user may be an employee represented in the employee database or a manager of the employees, or another person associated with the organization.

The user interface 300 shown in FIG. 1 displays the thumbnail view 312 in the employee display panel. The thumbnail view 312 displays thumbnail images 314, 316 each representing an employee stored in the employee database. A user can scroll through a collection of thumbnail images 314, 316, for example, by using scrolling functionality of a computing device on which the user interface 300 is displayed. For example, if the user interface 300 is displayed on a tablet device having a touch screen, the user may be able to drag a finger down the touchscreen to scroll down to additional thumbnail images.

Each thumbnail image 314, 316 displays a name 318 and a photograph for the employee that the thumbnail image represents. Some thumbnail images 316 also display an indicator representing additional possible characteristics 322 describing an employee, for example, an indicator describing an employee as a contractor. In some embodiments, the employees are organized by last name from A to Z, but by invoking the title 303, the user can reverse the order.

In some embodiments, all of the employees in an employee database are displayed in the user interface 300 by default. The employees displayed in the user interface 300 by default may also represent a subset of employees in an employee database, for example, employees authorized to be viewed by a particular user of the user interface 300.

The user interface 300 also allows a user to filter or narrow the collection of employees displayed at a given time. For example, the user interface 300 provides selectable search criteria that can be selected to narrow the collection of employees based on the criteria. In the user interface of FIG. 1, a panel 305 on the left side of the screen contains options for navigation and selection of employees.

In other aspects, a selectable search criteria in panel 305 of the user interface 300 includes criteria within various categories, including for example location 324, employment type 326, potential 328, and performance rating 330. Within each category, possible values are shown, together with the number of employees who fall within the category. As another example, a user can select one or more criteria associated with location 324 (for example, by touching “New York” and “Boston”) to limit the employees displayed to those employees in particular locations such as particular cities. It is clear that the specific illustrations and discussion of the various embodiments here is not exhaustive or limiting. Rather, other examples can be developed using the same and similar techniques.

A user can select one or more criteria associated with employment type 326 to limit the employees displayed to employees having one or more particular types, e.g., salaried employee, hourly employee, and contractor. A user can select one or more criteria associated with potential 328 to limit the employees displayed to employees having one or more particular levels of potential for professional advancement, e.g., high potential, medium potential, or low potential. A user can select one or more criteria associated with performance rating 330 to limit the employees displayed to employees having one or more particular levels of professional performance, e.g., a level scored on a scale from one to five.

In the thumbnail view 312 (and also in other reviews), a user can make selections within one or more of the selectable search criteria and perform a search of employees in the employee database to display thumbnail images 314, 316 representing employees matching the selectable search criteria. For example, the user can select some of the selectable search criteria (e.g., by touching buttons 332, 334 representing search criteria) and then press a search button 336 to execute a search of the employees based on the selected search criteria. In some examples, the employees displayed in the thumbnail view 312 are narrowed automatically upon the selection of a search criterion, e.g., when one of the buttons 332, 334 representing search criteria is pressed.

In some implementations, the user interface 300 allows a user to save a search that has been performed. For example, a user can select search criteria and press a save button 338 to save the search criteria selected and perform the same search at a later time. The user can also press a reset button 338 to deselect all of the selected search criteria.

Each time search criteria are applied and the number of employees shown in the employee display panel changes, the number of them as indicated in title 303 is updated.

In some implementations, the user interface 300 provides buttons on the right side of the selection panel that allow a user to select a viewing mode. For example, the user interface 300 can include a basic mode (button 342), an advanced mode (button 344), a saved searches mode (button 346), and a favorites mode (button 348).

The system described may include a default or basic mode of operation as well as other, advanced or optional modes of operation. Access levels and optionally installed features or upgrades may determine the specific feature set of functions available by the system. The advanced mode can be a mode displaying additional search options and additional information about employees. The saved searches mode can display searches saved by a user using the save button 338. The favorites mode can display a subset of employees identified as “favorites” by a user.

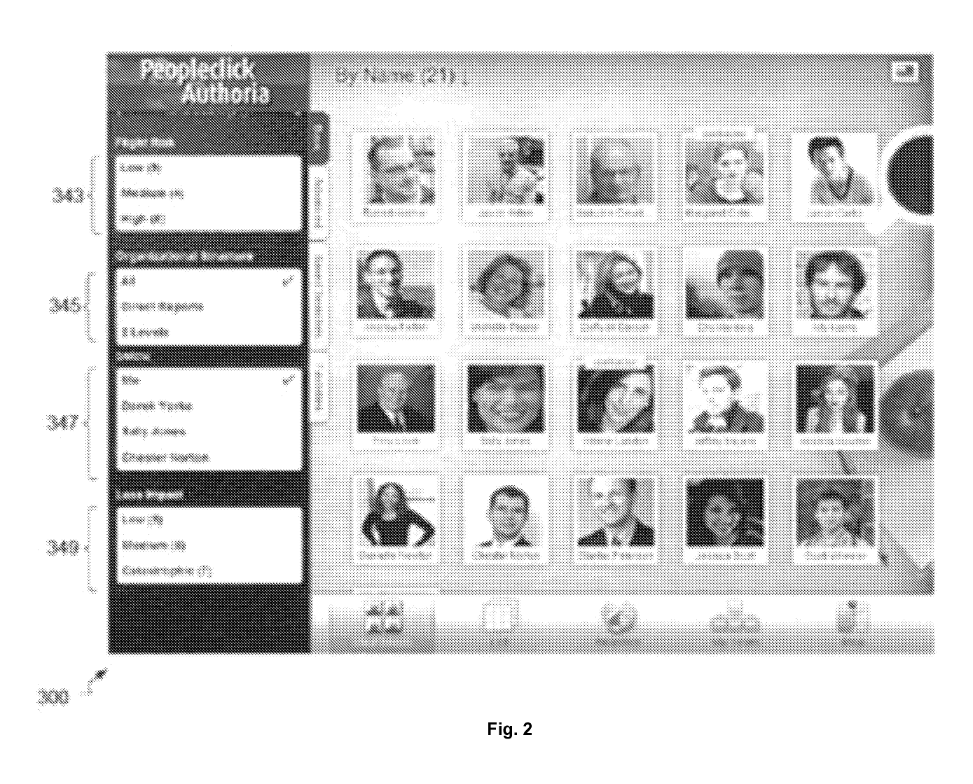

FIG. 2 illustrates additional selectable search criteria in the user interface 300. In some implementations, the additional selectable search criteria in the user interface 300 can include flight risk 343, organizational structure position 345, supervisor 347, and loss impact 349. For example, a user can select one or more criteria associated with flight risk 343 to limit the employees displayed to those employees having one or more particular levels of risk of departing the company, e.g., low risk, medium risk, or high risk.

In an embodiment, a user can select one or more criteria associated with organizational structure position 345 to limit the employees displayed to employees having a particular place in the company's organizational structure relative to the user, e.g., directly reporting to the user, or two levels below the user. A user can select one or more criteria associated with supervisor 347 to limit the employees displayed to employees having one or more particular supervisors. A user can select one or more criteria associated with loss impact 349 to limit the employees displayed to employees having one or more particular levels of impact upon the company were the employee to depart, e.g., low impact, medium impact, or catastrophic impact.

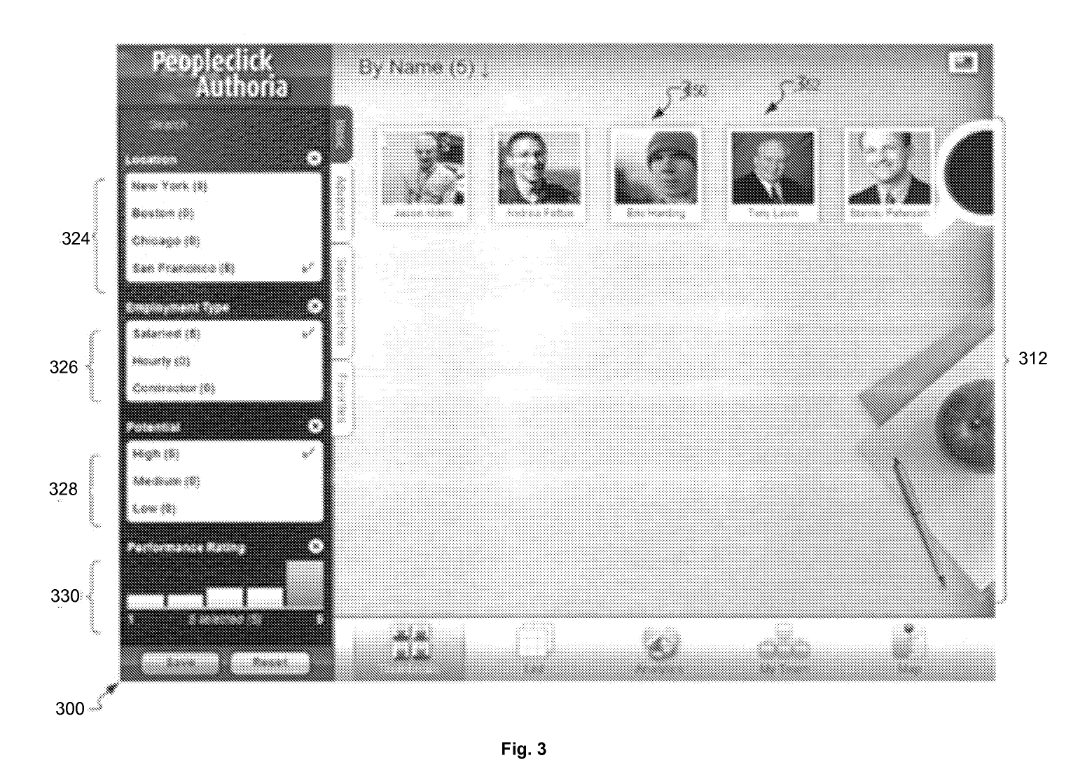

FIG. 3 illustrates the results of a search using the selectable search criteria in the user interface 300. In the example shown, a search of the employees has limited the employees shown in the thumbnail view 312. In particular, the location 324 has been limited to employees in San Francisco, the employment type 326 has been limited to salaried employees, the potential 328 has been limited to employees having high potential, and the performance rating 330 has been limited to employees having a performance rating of five (5). The thumbnails 350, 352 shown in the thumbnail view 312 of the user interface 300 meet these selected criteria.

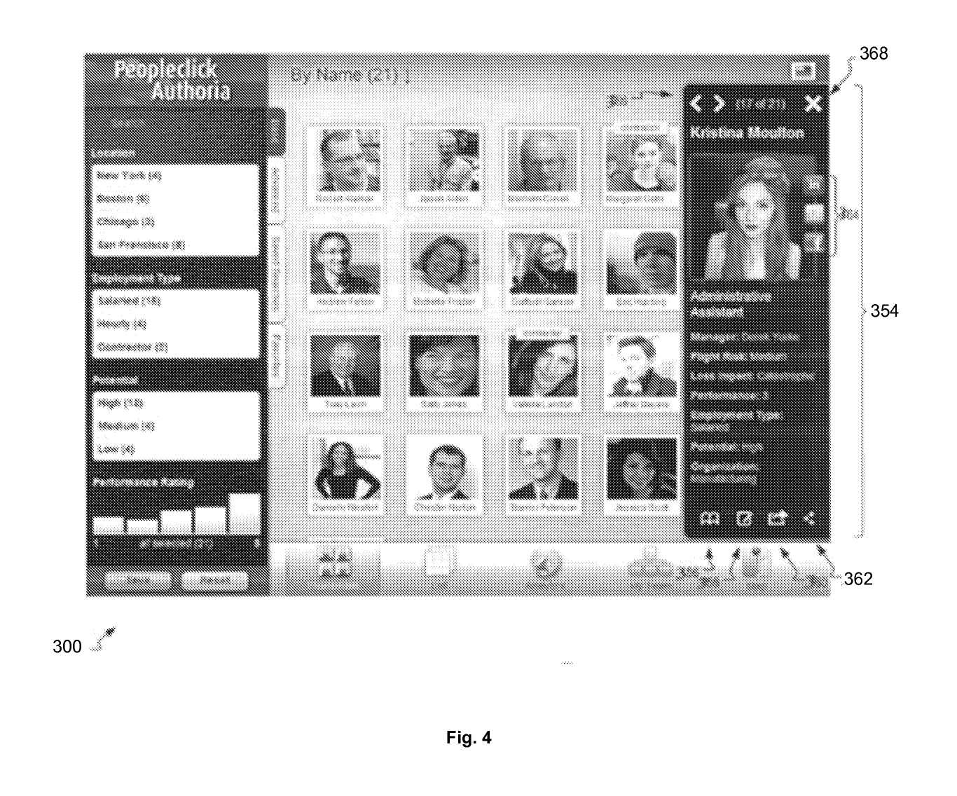

FIG. 4 illustrates how a user can select a thumbnail in the thumbnail view 312 (or, in other views, choose an employee on a list, for example), of the user interface 300 to access a pop up window showing a summary 354 of the employee represented by the thumbnail. The summary 354 contains information describing the employee obtained from the employee database. In some implementations, the summary 354 includes buttons that, when touched, provide access to a full employee profile (button 356), allow a user to compose a message to the employee (button 358), transmit the summary (or an employee profile) in an email message or other communications medium (button 360), or display an organizational chart showing the employee's position in the company's hierarchy (button 362).

The summary 354 also includes buttons 364 that access the employee's profile on social networking services. The summary 364 also provides navigation buttons 366 that allow a user to move forward and backward among other summaries of the employees shown in the user interface 300, and a close button 368 to dismiss the window containing the summary 354.

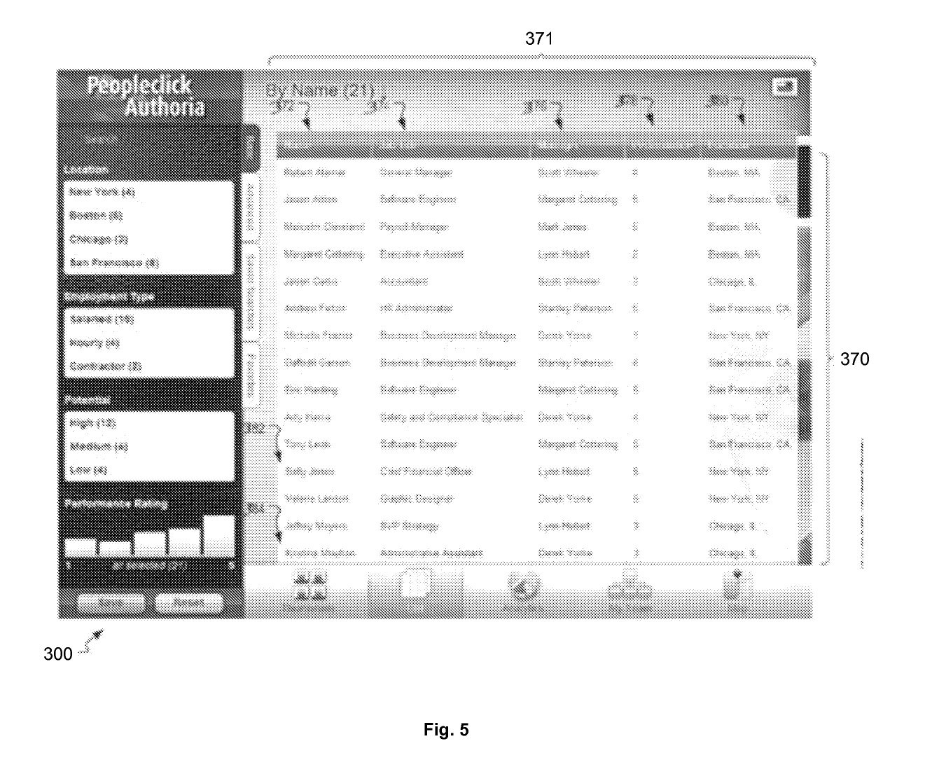

FIG. 5 illustrates a list view 370 of the user interface 300. For example, the list view 370 can be accessed by touching a view list view button. The list view 370 shows a table of information about employees, including columns 371 representing employee name 372, employee job title 374, employee manager 376 (e.g., employee supervisor), employee performance rating 378, and employee location 380. Each row 382, 384 represents an employee, in the same way that each thumbnail of the thumbnail view 312 represents an employee. The rows 382, 384 can be sorted, for example, sorted by the contents of one or more of the columns 371.

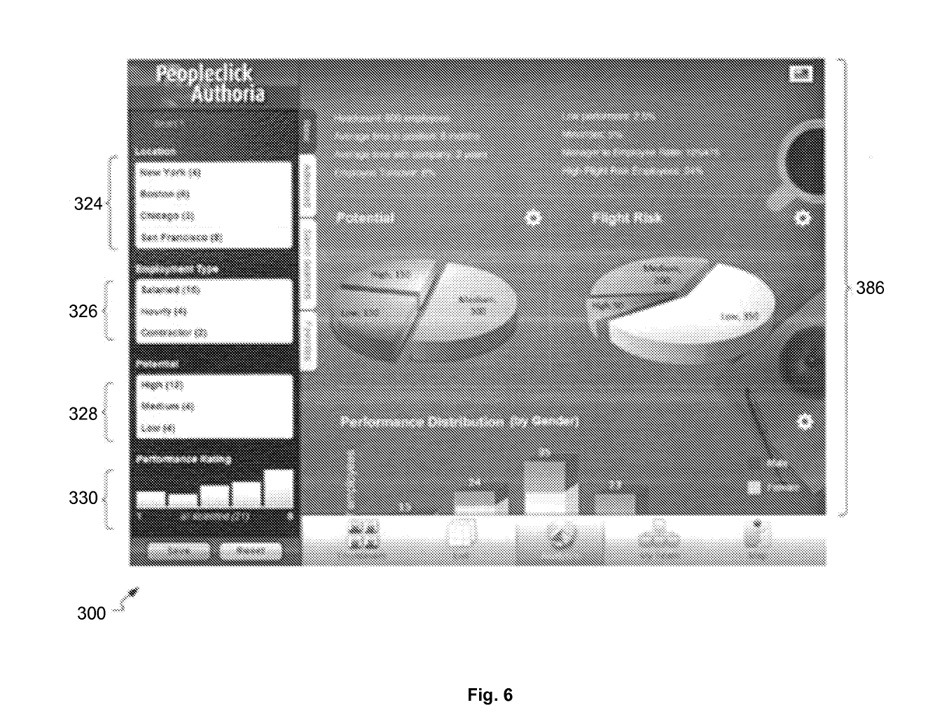

FIG. 6 illustrates an analytics view 386 of the user interface 300. For example, the analytics view 386 can be accessed by pressing the analytics view button 306 (FIG. 1). The analytics view 386 shows statistics and analysis about the employee data stored in the employee database. The analytics view 386 can show statistics for all employees, for example, or a subset of employees chosen according to the search criteria, for example, location 324, employment type 326, potential 328, and performance rating 330. The analytics are the result of the analysis of underlying data that may be useful for a manager of the employees. The analytics can relate to the potential of the employees, their flight risk, the loss impact, and others, for example. The analytic can be displayed graphically as a pie chart or a bar chart, or in other ways.

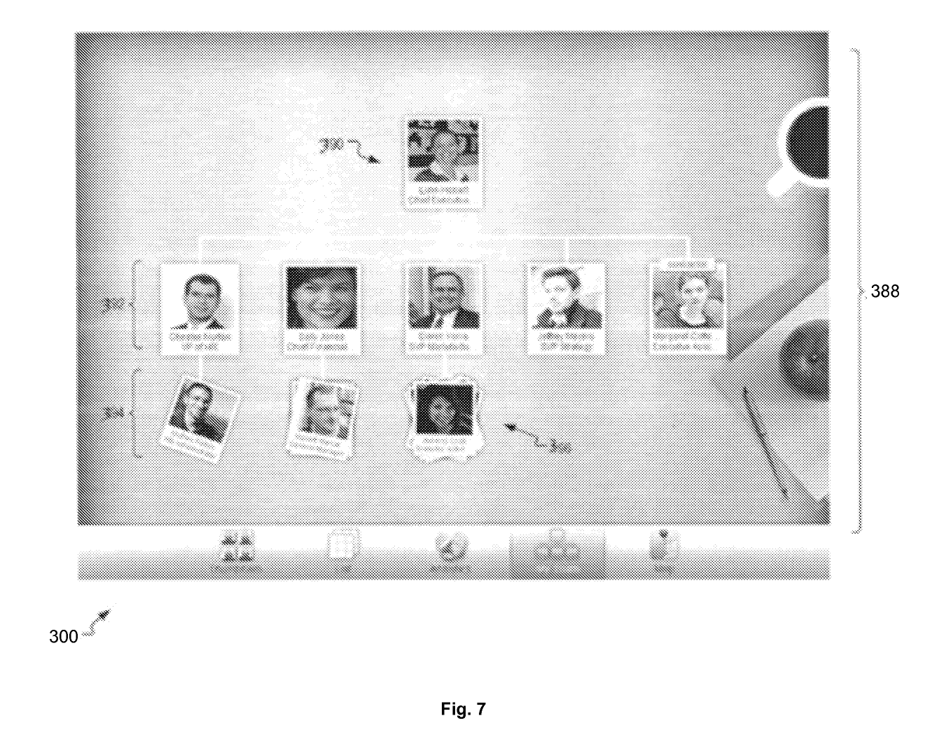

FIG. 7 illustrates the team view 388 of the user interface 300. For example, the team view 388 can be accessed by pressing the team view button 308 (FIG. 1). The team view 388 shows an organizational chart of employees having a relationship to an employee. In particular, the team view 388 shows a thumbnail 390 of an employee, for example, a thumbnail 390 chosen (e.g., clicked or selected) in the thumbnail view 312 (FIG. 1) or a thumbnail of a user of the user interface 300. The team view 388 also shows thumbnails 392 of employees linked to and positioned under the employee represented by the thumbnail 390. For example, the thumbnails 392 may represent employees who report to or are supervised or managed by the employee represented by the thumbnail 390. Each of the thumbnails 392 may be linked to other thumbnails 394 of employees who report to the employees represented by the thumbnails 392. In some examples, a thumbnail collection 396 is shown representing multiple employees reporting to another employee. A user can click the thumbnail collection 396 to expand the collection into thumbnails of individual employees.

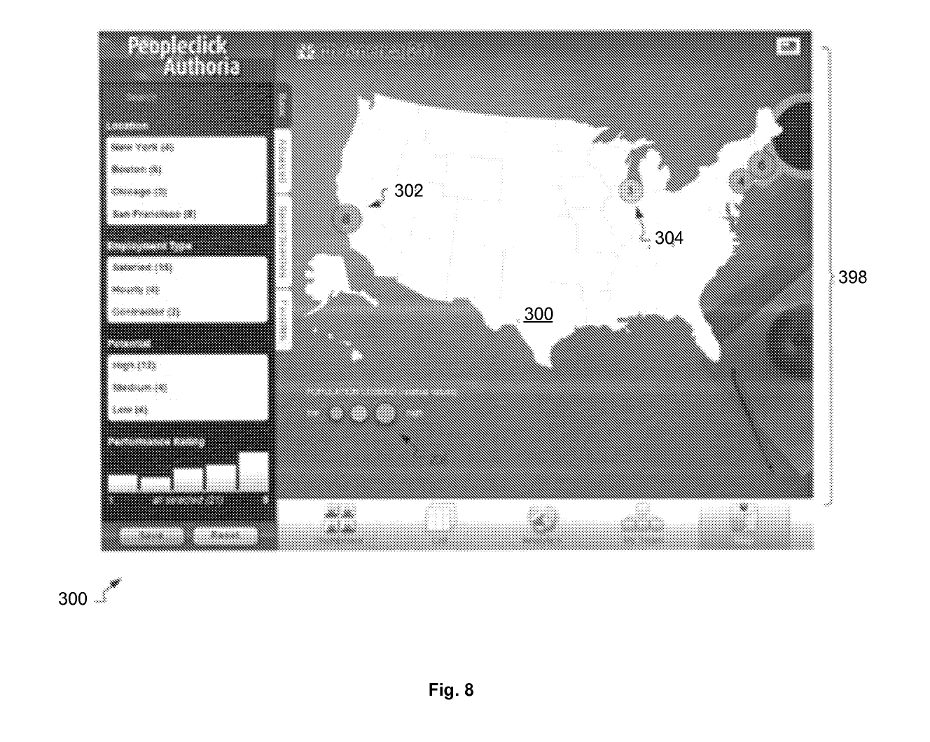

FIG. 8 illustrates a map view 398 of the user interface 300. For example, the map view 398 can be accessed by pressing the map view button 310 (FIG. 1). The map view 398 shows a map 400 of the geographical locations of employees represented in the employee database. For example, the map 400 can include graphical clusters 402, 404 representing groups of employees who work at offices of a company. The graphical clusters 402, 404 represent multiple employees and can include a number indicating how many employees work at that location. Graphical clusters can have a color and/or size that varies depending on the number of employees. For example, a cluster having a higher number of employees (e.g., higher than a threshold value) can be shown in blue, while a cluster 404 having a lower number of employees can be shown in red. The color and/or size can be indicated by a legend 406.

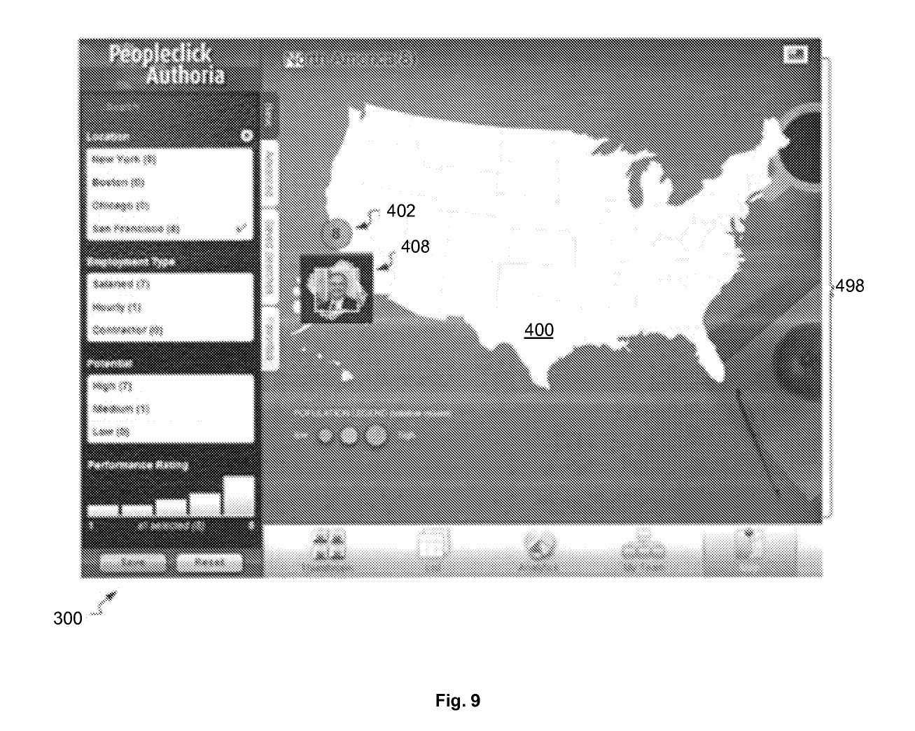

FIG. 9 illustrates another exemplary user interface output 300 including a map region 498 containing a map 400 and including a geographic location 402 at which eight employees are employed. Thumbnail image depictions of the eight employees are shown in the graphical user interface as a stack of thumbnail images 408.

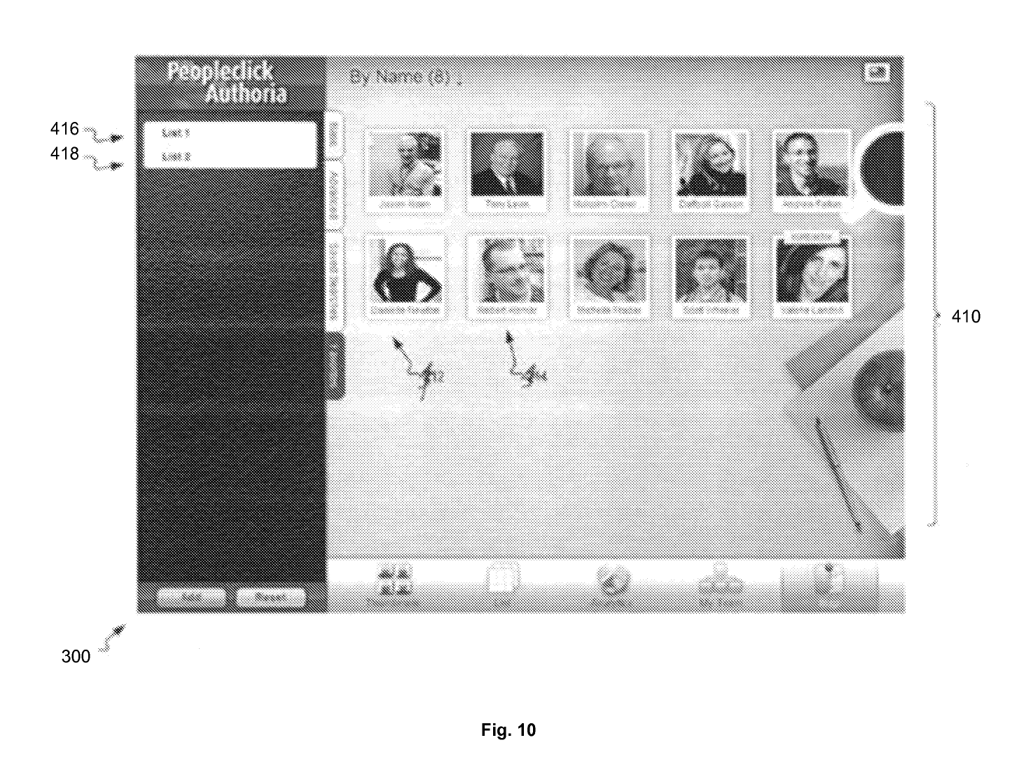

FIG. 10 illustrates a “favorites” or preferred viewing mode 410 of the user interface 300. For example, the favorites viewing mode 410 can be accessed by pressing the favorites mode button. The favorites viewing mode 410 shows a subset of employees who have been identified as favorites by a user of the user interface 300. For example, the favorites viewing mode 410 can show thumbnails 412, 414 representing the employees. The employees who have been identified as favorites can also be organized into lists (represented as buttons 416, 418) that can be selected for display in the user interface 300. For example, a user of the user interface 300 can assign employees to the lists.

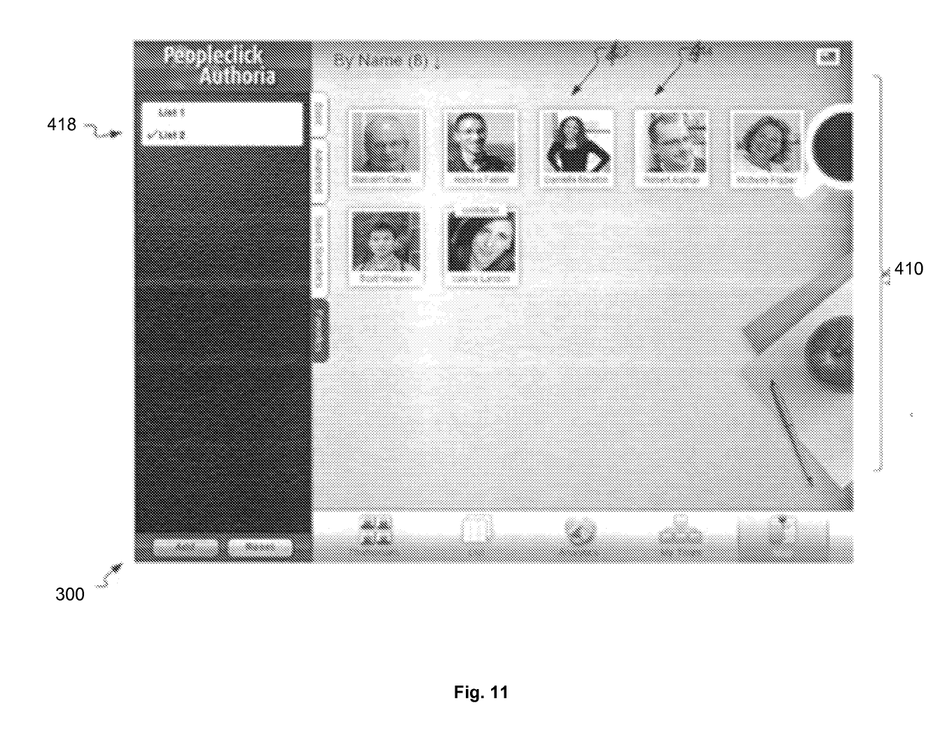

As shown in FIG. 11, within the favorites viewing mode 410, a user can select one of the lists (e.g., by clicking a button 418 representing the list). The selection of the list causes the user interface 300 to display thumbnails 412, 414 representing employees assigned to the list, rather than thumbnails representing all of the employees identified as favorites.

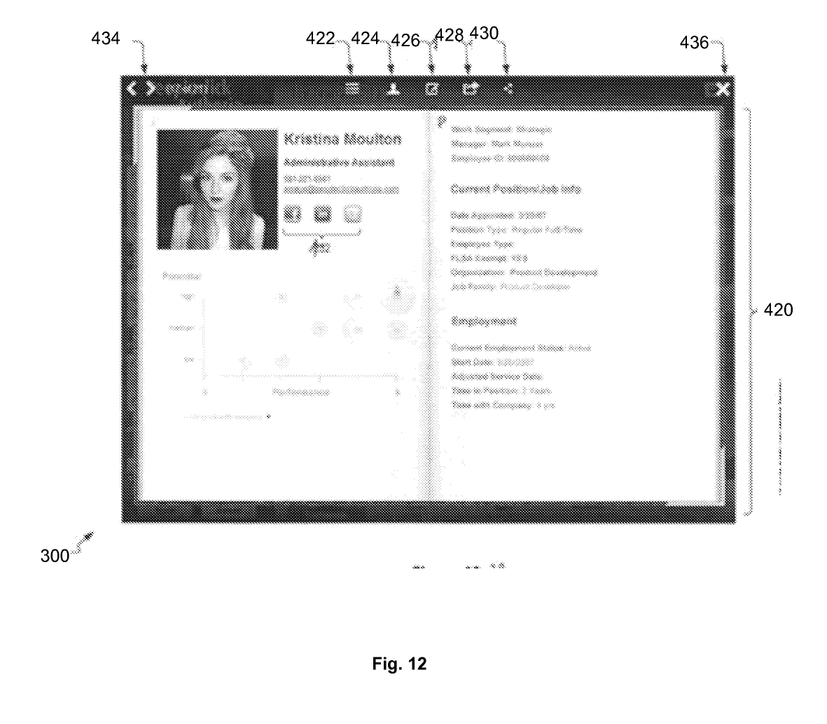

FIG. 12 shows an employee profile 420 displayed in the user interface 300. The employee profile can provide detailed information about an employee represented in the employee database. For example, a user can access the employee profile by clicking an employee profile button or icon on an employee summary 454 (e.g., FIG. 4). In some implementations, the employee profile 420 includes buttons that, when clicked, provide access to an additional data menu (button 422), provide access to a second additional data menu (button 424), allow a user to compose a message to the employee (button 426), transmit the employee profile in an email message or other communications medium (button 428), or display an organizational chart showing the employee's position in the company's hierarchy button 430 (e.g., FIG. 7). The employee profile 420 also includes buttons 432 that access the employee's profile on social networking services. The employee profile 420 also provides navigation buttons 434 that allow a user to move forward and backward among other employee profiles available in the user interface 200, and a close button 436 to dismiss the window containing the employee profile 420.

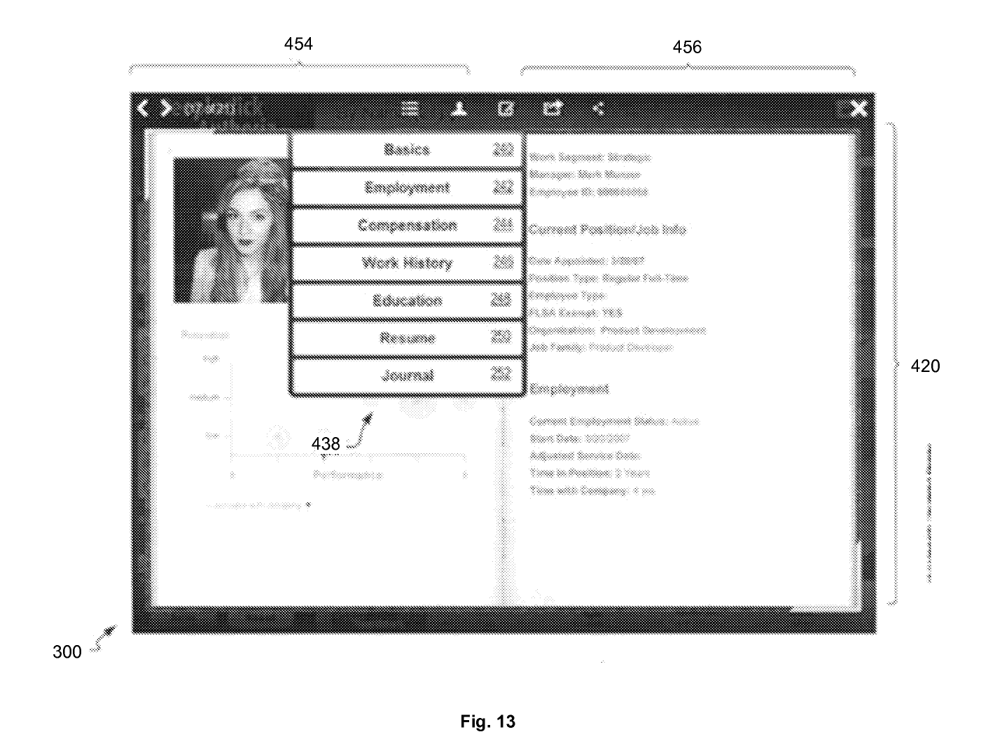

FIG. 13 illustrates an additional data menu 438 displayed over the employee profile 420. For example, a user can access the additional data menu 438 by clicking the additional data menu button 422 (FIG. 2). The additional data menu 438 provides buttons that a user can click to access additional data about the employee represented in the employee profile 420. For example, the additional data menu 438 can include a basics button 440, an employment button 442, a compensation button 444, an education button 448, a resume button 450, and a journal button 452.

The basics data 454 accessible by the basics button 440 and the employment data 456 accessible by the employment button 442 are represented in FIG. 3 (and also visible in FIG. 2). For example, the basics data 454 can include information about the employee's potential for advancement, and the employment data 456 can include information about the employee's current position.

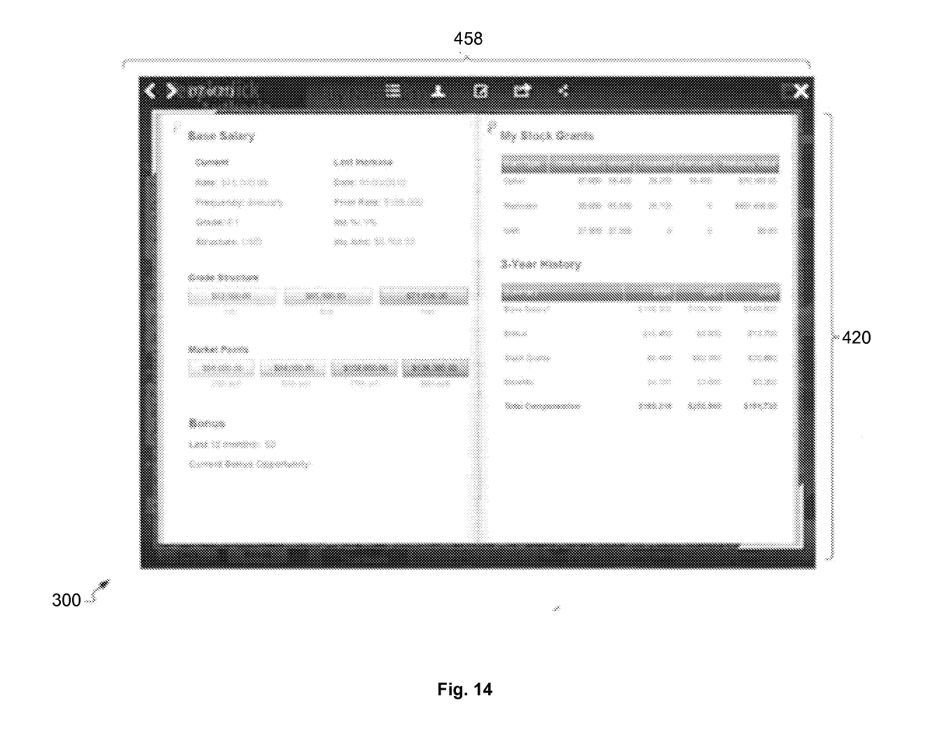

The compensation data 458 accessible by the compensation view is represented in FIG. 14. For example, the compensation data can include information about the employee's salary and benefits.

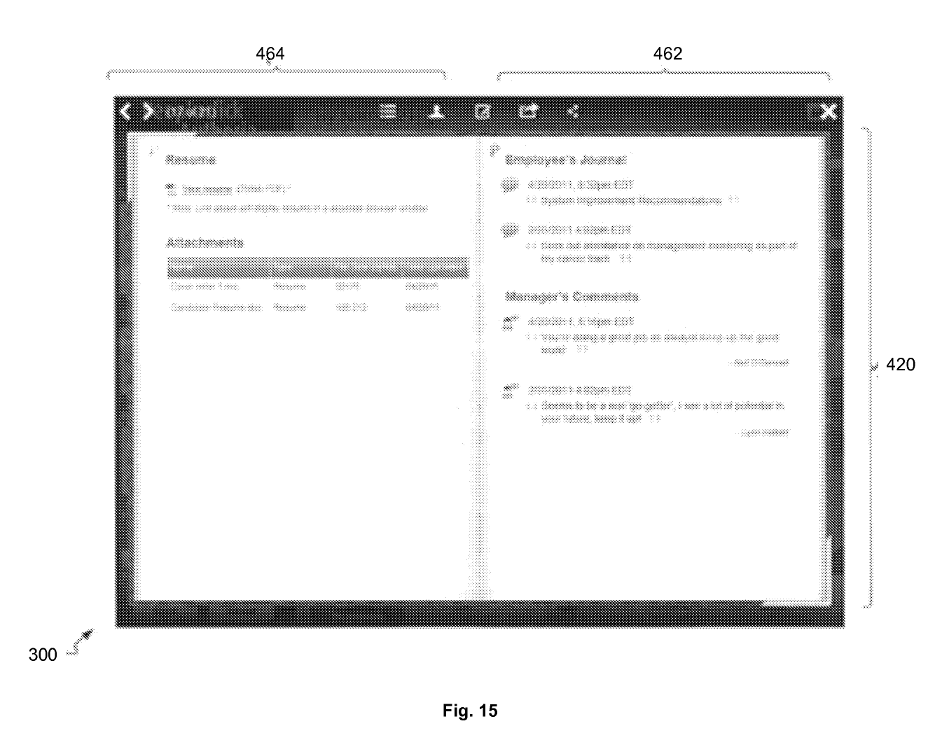

The journal data 462 is accessible by the journal button 452 and the resume data 464 accessible by the resume button 450 is represented in FIG. 15. For example, the journal data 462 can include information about feedback received from the employee and about the employee, and the resume data 464 can include the employee's resume and cover letter documents.

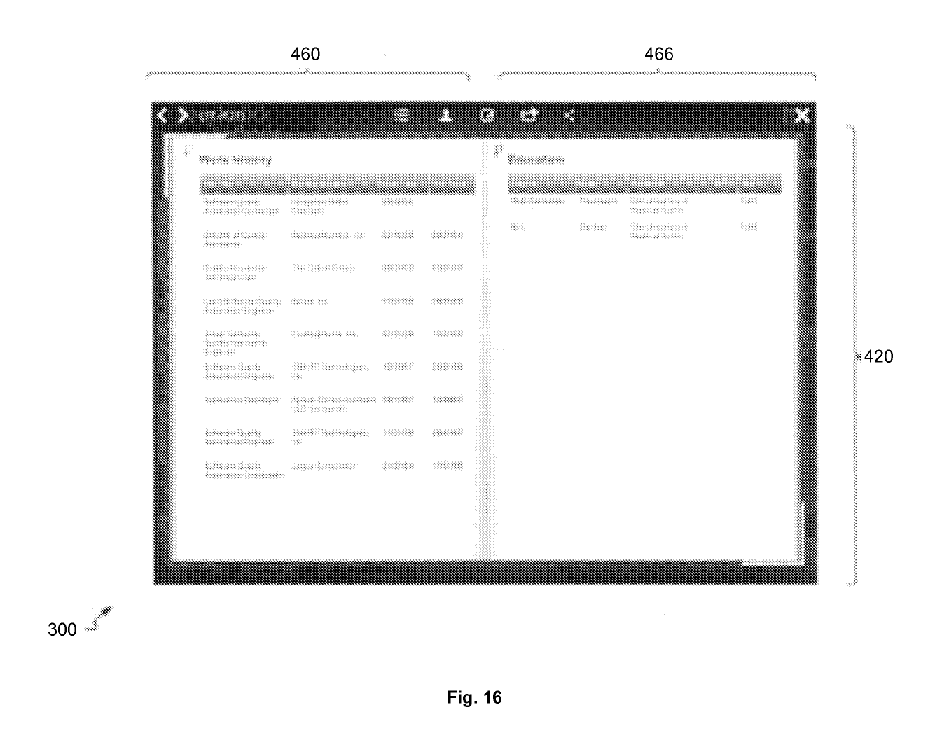

The work history data 460 accessible by the work history button 446 and the education data 466 accessible by the education button 448 are represented in FIG. 16. For example, the work history data 460 can include information about the employee's past occupations and places of employment, and the education data 466 can include the information about the employee's degrees and academic institutions.

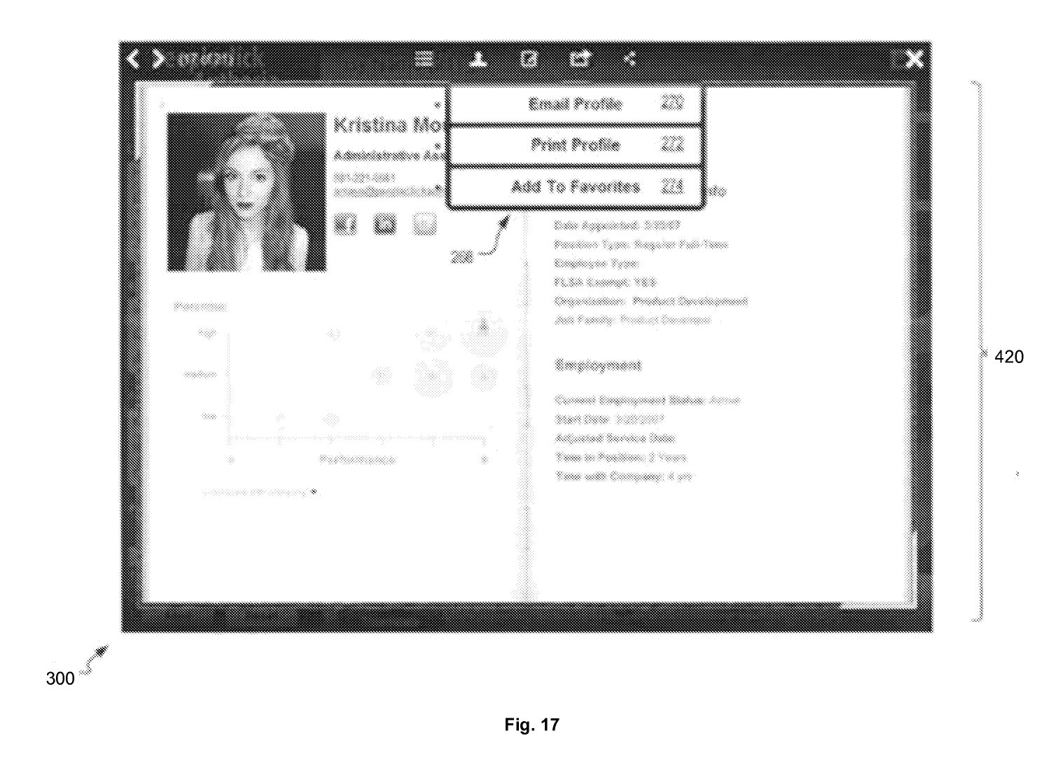

FIG. 17 illustrates a transmit profile menu 468 displayed in the user interface 300 over the employee profile 420. The transmit profile menu 468 provides buttons that a user can click to transmit the employee profile 420 using one of several communications techniques. For example, the transmit profile menu 468 can include an email button 470 for sending the profile (or a hyperlink to the profile) in an email (e.g., to another user). The transmit profile menu 468 can also include a print button 472 for printing a hard copy of the employee profile 420. The transmit profile menu 468 can also include a favorites button 474 for adding the employee represented by the employee profile 420 to a list of favorites (e.g., for display in the favorites viewing mode for 10 of shown in FIG. 10).

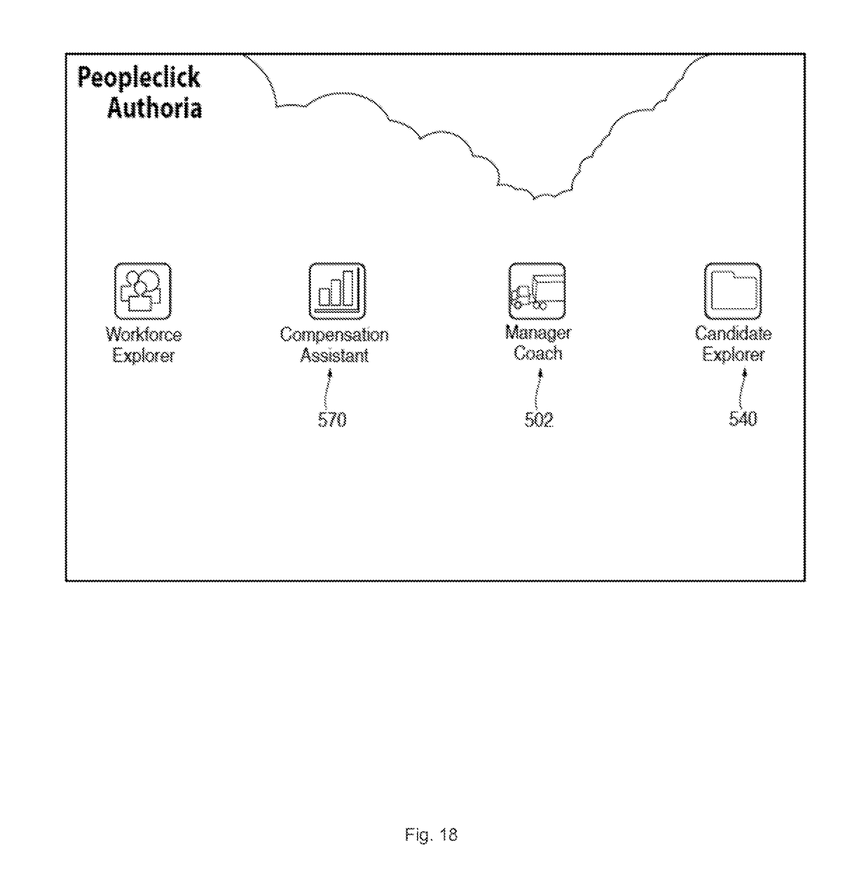

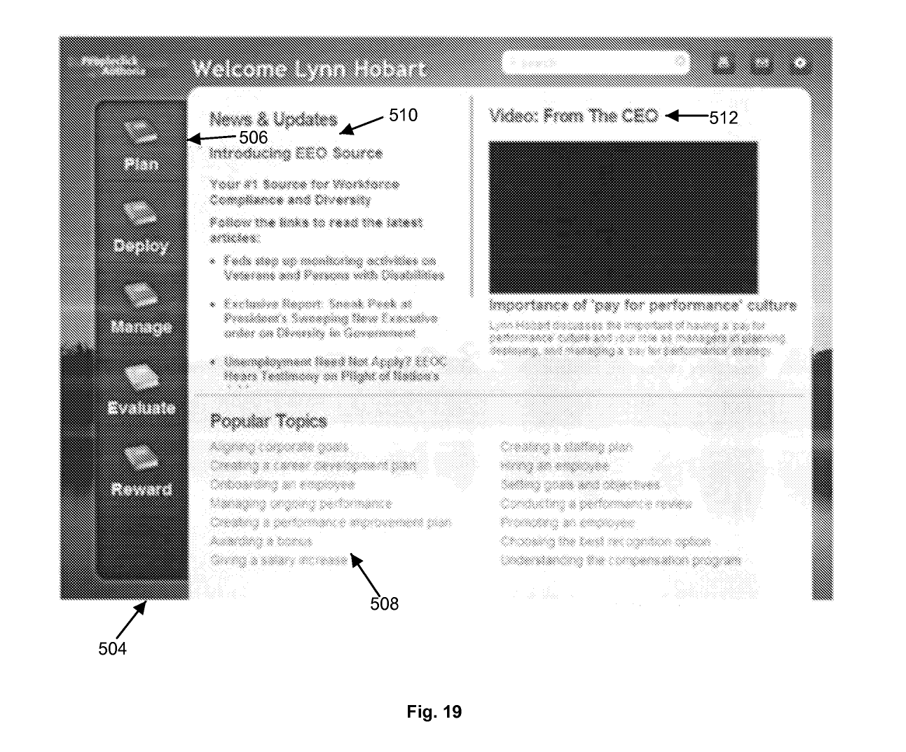

As shown in FIG. 19, the manager coach application 502 that is available from the icon set of FIG. 18 provide information that managers may need to know about their HR responsibilities and role within the organization. The application provides manager advice on the mobile computing device (e.g., iPad® or similar product) to allow personalized coaching to be in a manager's hands at the time she deals with real workforce issues. This application provides a fluent dialogue between employee relations staff of an entity and the front-line managers handling every day workforce issues.

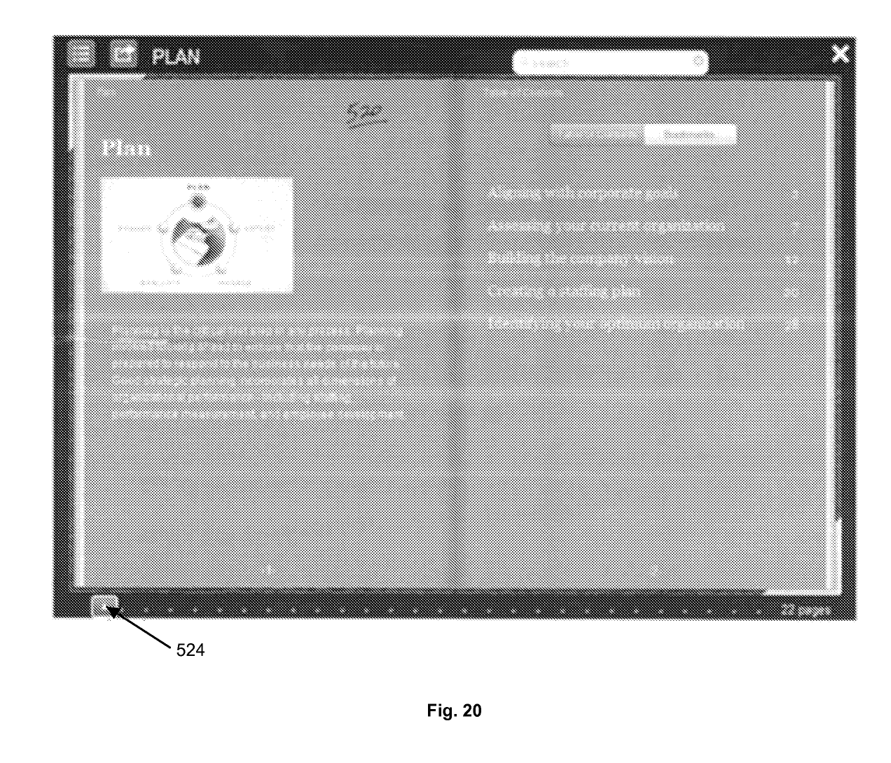

FIG. 19 illustrates an exemplary interface 504 that includes tabs 506 in a column on the left side. The tabs divide the topics that are of most significant to the manager, in this case including planning, deploying, managing, evaluating, and rewarding. The interface 504 also lists links 508 associated with popular topics of concern to a manager. News and updates 510 provide current information for the manager, and videos can be presented by the employee relations staff in a video window 512. When the user touches any of the tabs 506, a flipbook 520 (FIG. 20) opens and can be read page by page by the user. A slider 524 enables navigation to any desired page.

More than one related application (sometimes known as applets, apps, or similar software components) may be bundled into a complementary set of features provided to users, each app or component activated by a user interface element, e.g., a button. The more than one app or component may be activated or sold individually as part of a suite of personnel management functions. In some example, a third application may be provided on the tablet computer is the compensation assistant 570, which is invoked by a corresponding icon 570 in FIG. 18.

The manager compensation assistant provides a tablet computer device experience that assists managers and the compensation professionals supporting them. It provides managers the ability to initiate off-cycle pay actions with full visibility into the impact on their budget. The app contains a compensation “flip book” to help better illustrate people investments while assisting managers in building their business case for recommended pay actions. It also provides visual rollups of budgets and a “budget cloud” illustrating potential challenges.

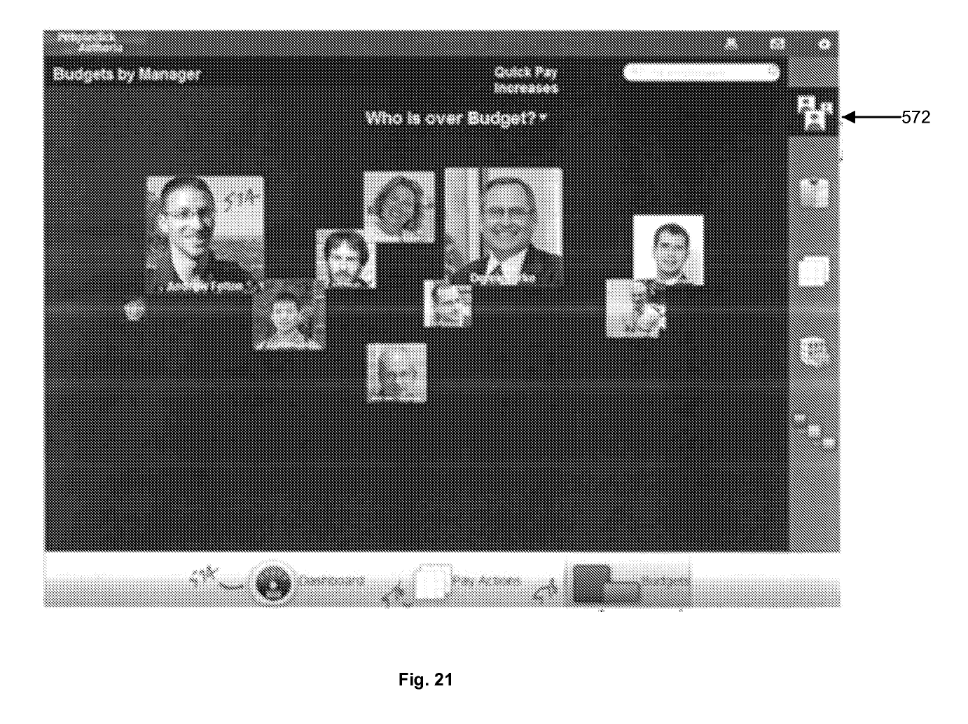

As shown in FIG. 21, the compensation assistant has a column of tabs 572 on the right-hand side each of which invokes a different view of compensation issues for the manager. The top icon represents a budget cloud of potential challenges for employee compensation relative to budget. The cloud is illustrated by thumbnail images 574 of individuals managed by the user. The sizes of the icons correspond to the size of the budget challenge associated with that person and his or her group. Along the bottom row of FIG. 21 are three buttons, dashboard 574, pay actions 576, and budgets 578. The budget cloud is part of the budgets feature of the compensation assistant, as shown.

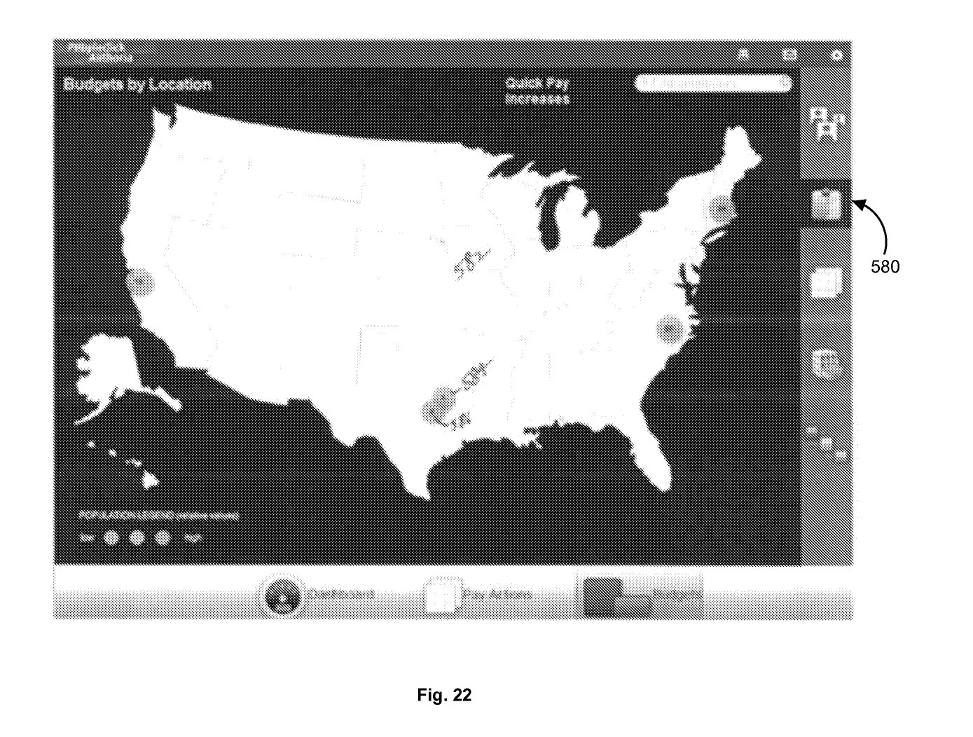

As shown in FIG. 22, when icon 580 is invoked, a map is displayed showing budgets by location. On a map 582 (in this case, a map of the United States), discs 584 are shown at the locations of the facilities where employees reporting to this user are stationed. Within each disc, a number 586 identifies the number of employees at that location.

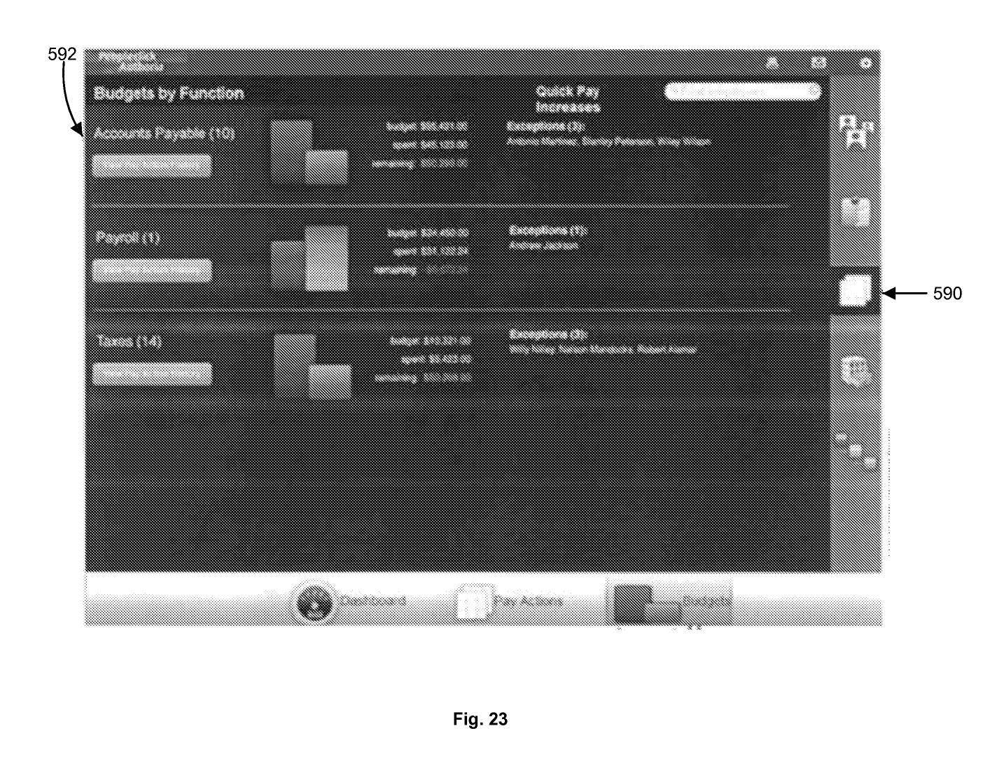

FIG. 23 illustrates how an icon 590 may be invoked in some embodiments. Information about budgets by function is shown in rows 592, including budget amounts, spent amounts, and remaining amount. Specific exceptions to the meaning of budgets are identified in the right column by name, for possible action.

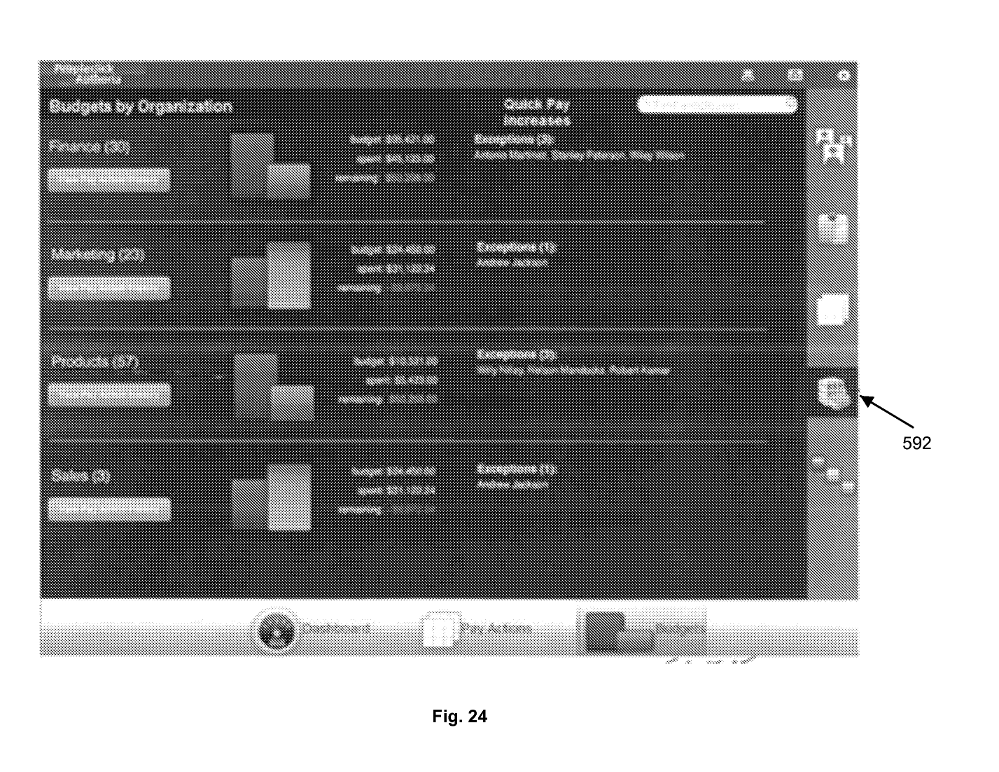

Referring to FIG. 24, when icon 592 is invoked, similar budget information is displayed in rows, except that it is organized by organizational unit rather than by function.

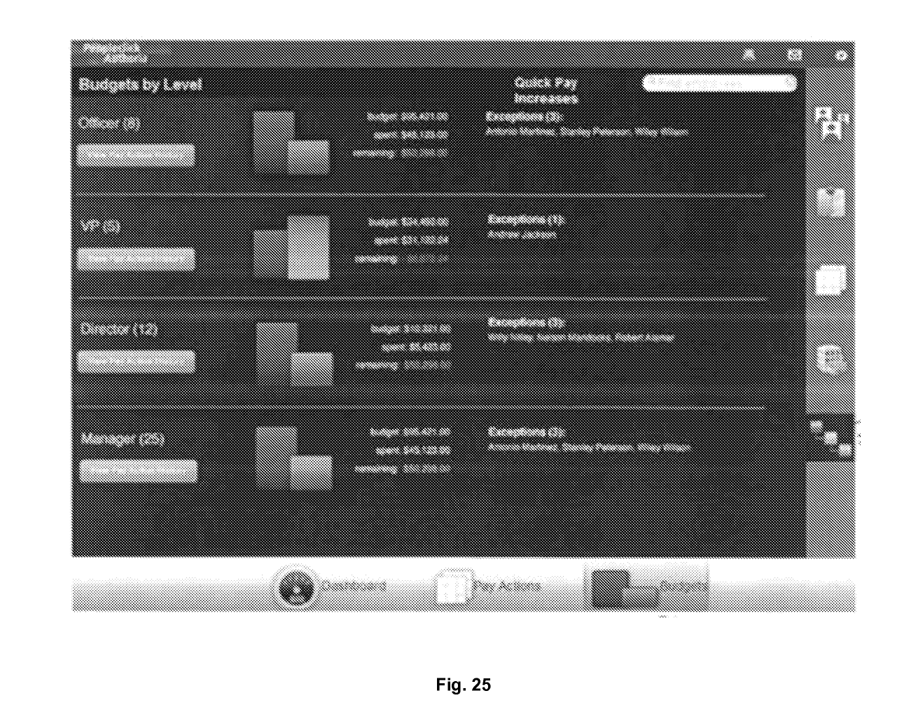

When icon 594 is invoked, as shown in FIG. 25, similar budget information is shown, organized by rows, each of which refers to a level of position in the organization structure.

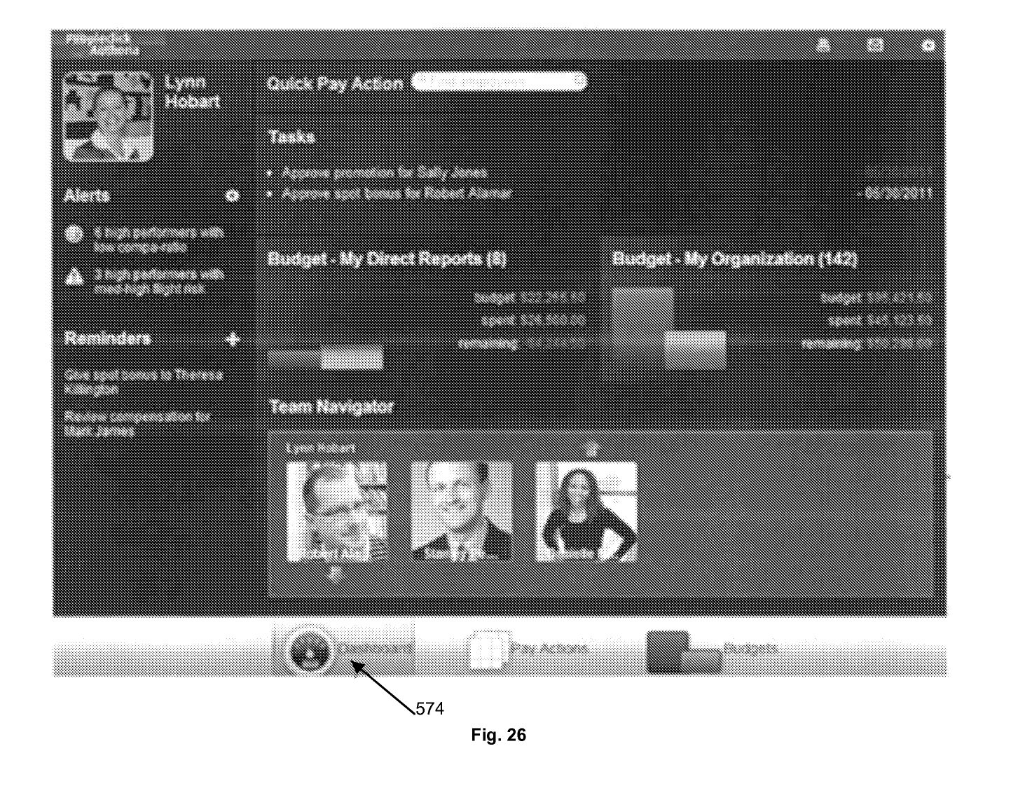

As shown in FIG. 26, when dashboard icon 574 is invoked, the user is presented with top-level information and a team navigator 596. The top level information includes tasks be done by this user, a thumbnail image in the name of the user in the upper left corner, alerts that need attention, reminders, a top-level budget for the user's direct reports and a top-level budget for the user's entire organization.

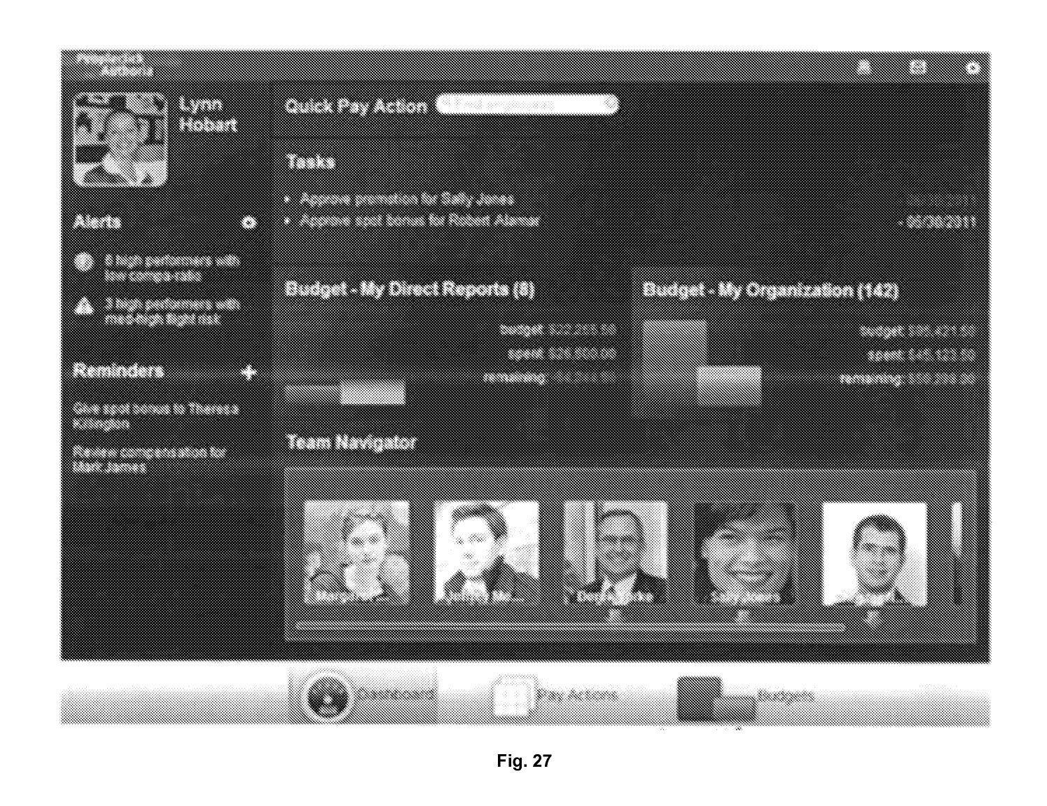

As shown in FIG. 27, the team navigator 596 enables the user to view all employees within her organization, level by level. For example, as shown in FIG. 26, Lynn Hobart has three direct reports—Robert, Stanley and Danielle. An arrow below Robert's thumbnail image can be clicked to expose employees who are in the hierarchy below Robert, as shown in FIG. 27.

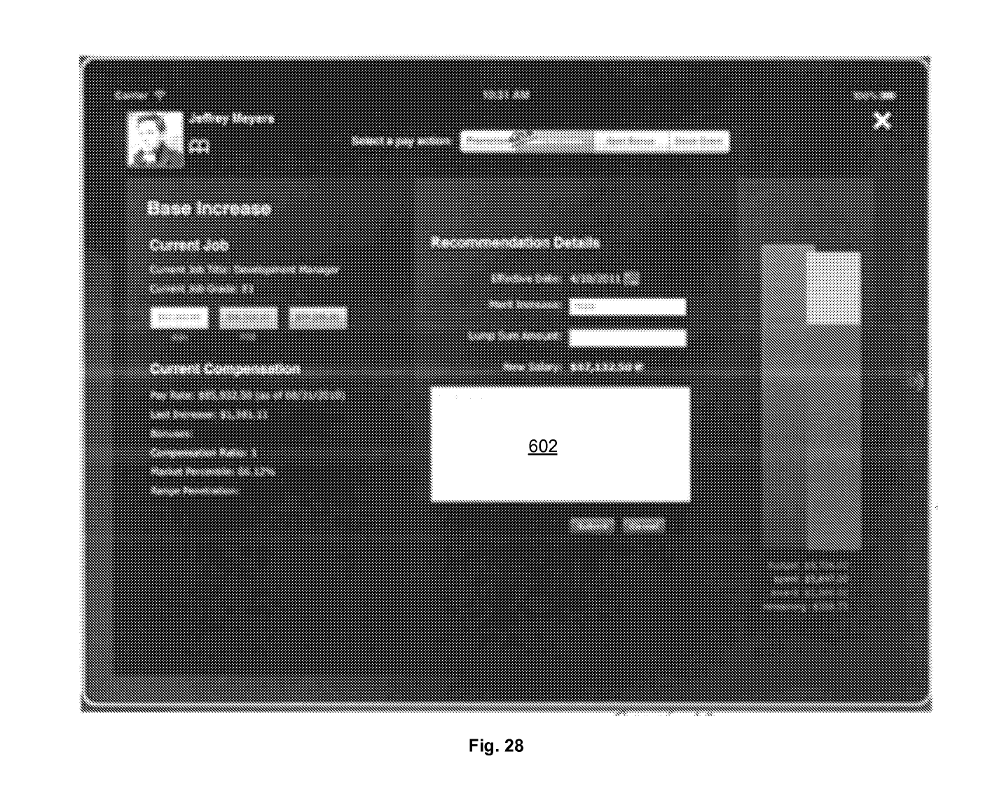

When the pay actions icon 576 in FIG. 21 is invoked, screen FIG. 28 appears, which enables the manager to conduct a pay action with respect to a selected employee, in this case Jeffrey Meyers. Four button 600 enables for different kinds of pay action: promotion, base increase, spot bonus, and stock grant. The screen identifies the current job title for this employee, the current job grade, and three different pay levels associated with that job grade, a minimum, a middle, and a maximum. History about the employees' compensation is also shown including a pay rate, the date when the pay rate began, the last increase, bonuses, and other information. On the right-hand side of the screen is shown a budgeted amount for merit increases, an amount already spent, an amount of the proposed award on this screen, and an amount that would remain in the budget after this award.

The center of the screen shows recommendation details for a pay action, in this case a base increase. The manager can indicate the amount of the merit increase, select the date of the merit increase, indicate a lump sum amount, and enter notes inbox 602 the new salary is also indicated. Similar screens are available for the promotion, spot bonus, and stock grant pay activities.

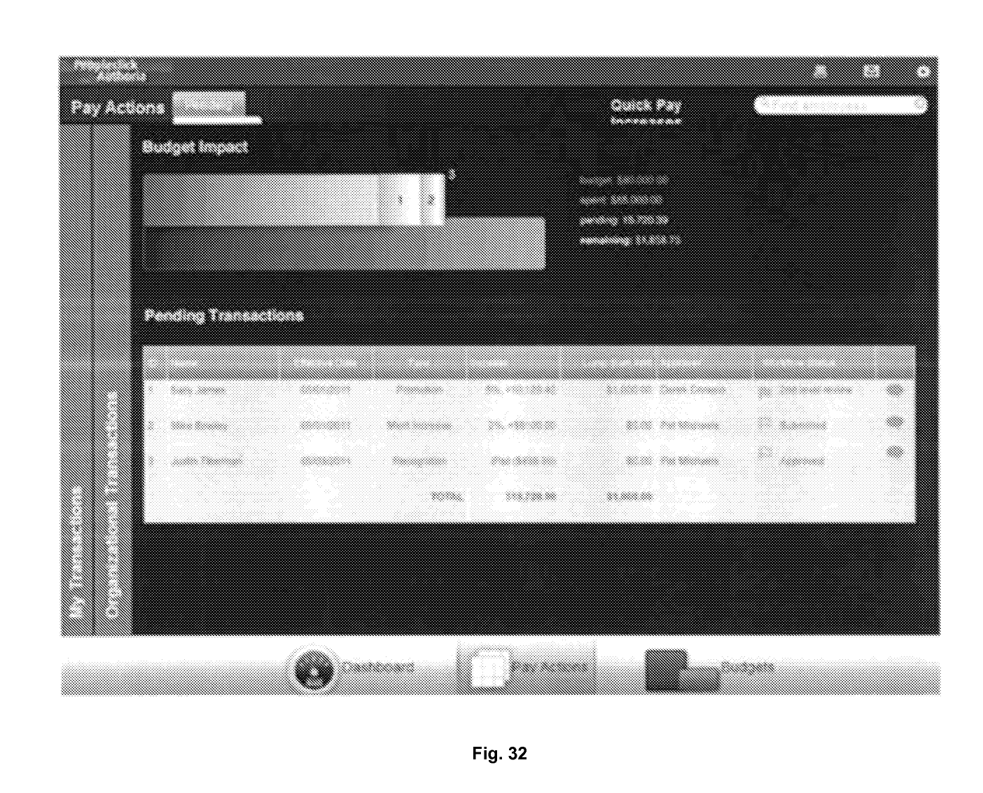

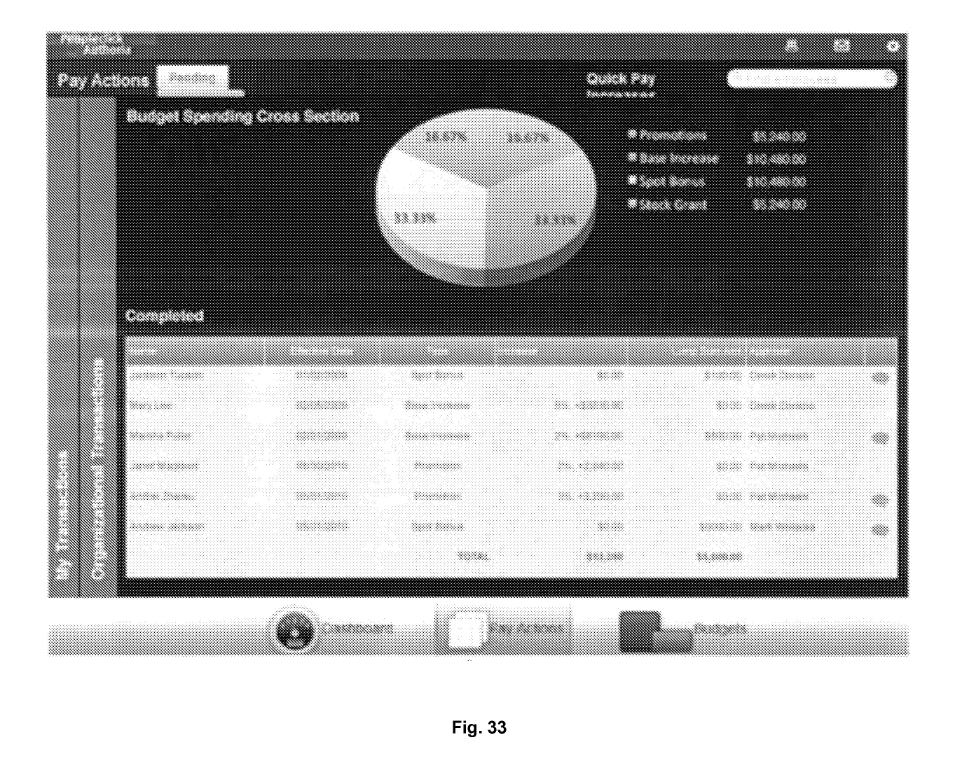

As shown in FIG. 32, another screen of the pay actions feature displays a list of pending transaction as well as horizontal bars illustrating the budget impact. The bars show the budget, the amount spent, the amount associated with the pending transaction, and the amount that will remain after they are affected. In FIG. 33, a list of completed transactions is shown at the bottom. At the top, a tight chart shows the proportion of the budget that has been spent on four categories of expenditure: promotion, base increase, spot bonus, and stock grant.

A fourth application in a suite of apps or software components is provided on the tablet computer as a candidate explorer application 540, which is invoked by a corresponding icon 540 on FIG. 18.

The candidate explorer app provides a unique way for hiring managers to review candidates on their requisitions. It surfaces the most important data to aid the hiring manager in making decisions about the quality and fit of each candidate.

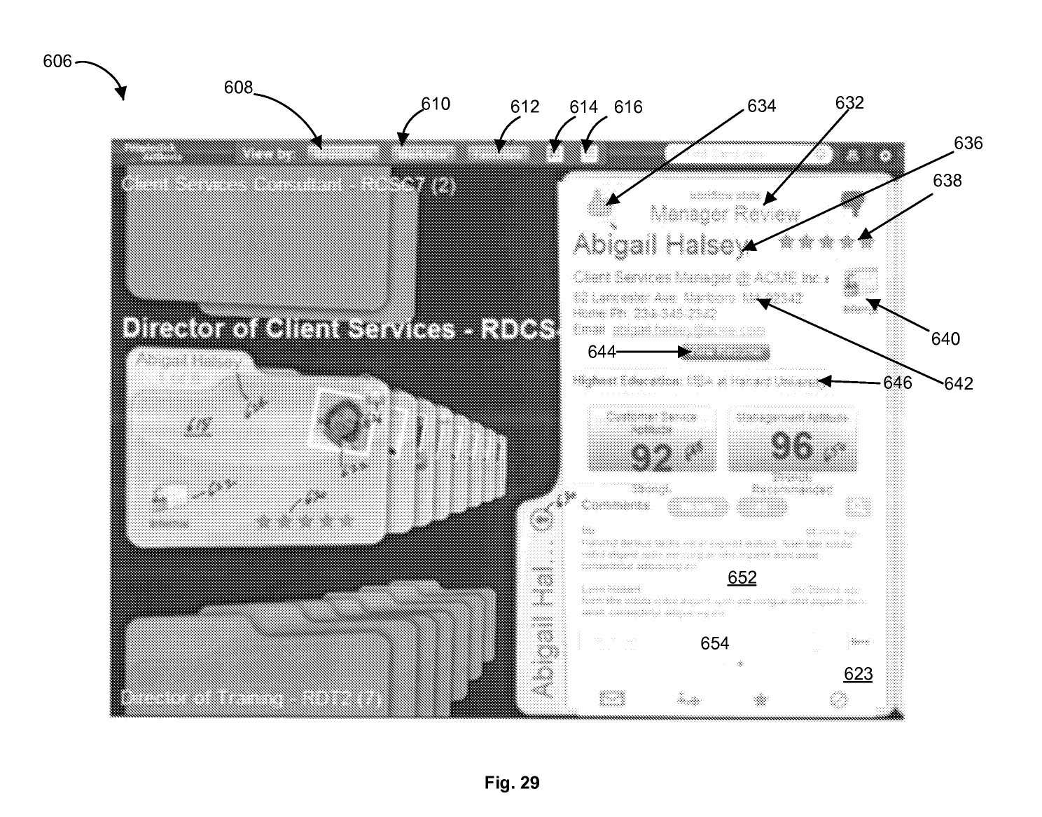

As shown in FIG. 29, the candidate explorer provides button 606 that enables selection of different views. Candidates can be viewed based on requisitions, the workflow sequence in which a candidate is identified, interviewed, and possibly hired, or based on favorites 612. The user can also, within any of those three views, choose to display as a gallery 614 or a list 616. In FIG. 29, the view is of requisitions on the left side, shown using a gallery display. In this case, the focus is on a requisition for a director of client services. The candidates represented by a stack of folders 618. Each folder bears a ranking (using one to five stars) 620, an indication of the accessibility 622 of the folder (for example, internal), a thumbnail 622, the candidate's name 624, and an indicator 626 of the importance of the folder. The user can navigate through the stack 618, or can navigate to other stacks using touch and swiping gestures on the surface of the display of the tablet computer.

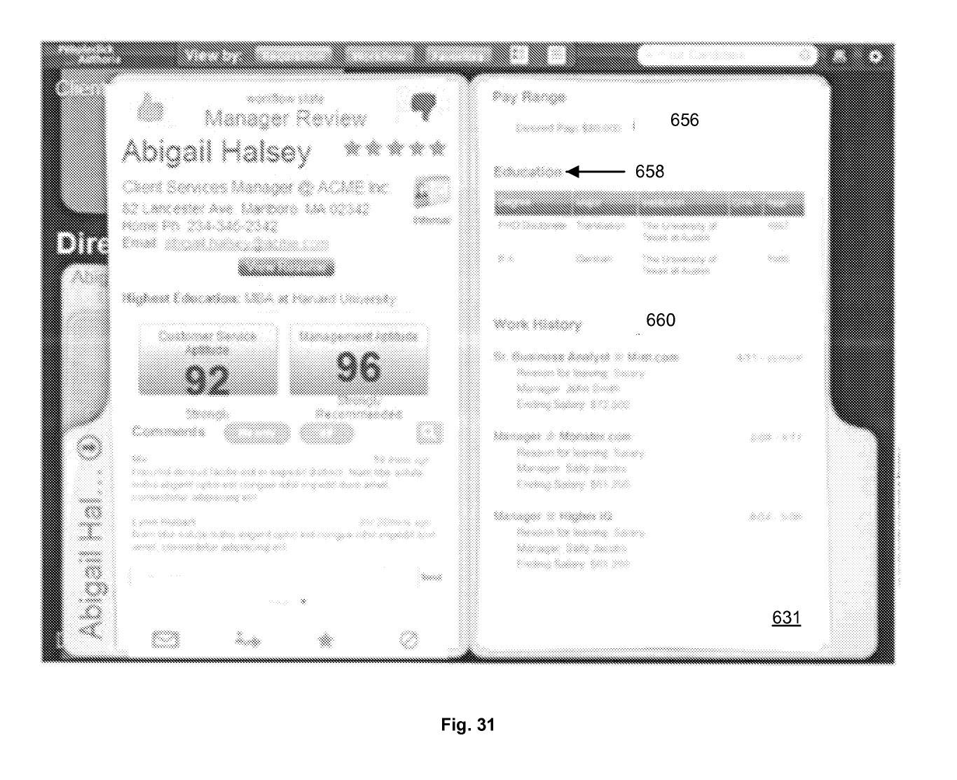

When a candidate's folder has the focus on the left side of the screen, a panel 623 is displayed on the right-hand side of the screen, containing detailed information about the candidate. By touching an arrow 630 or by dragging to the left, an additional panel of information about the candidate is opened, as shown in FIG. 31.

The panels 623 and 631 contain a set of important information about the candidate that is useful for the manager in making a hiring decision, and also contain features that enable the manager to take certain actions.

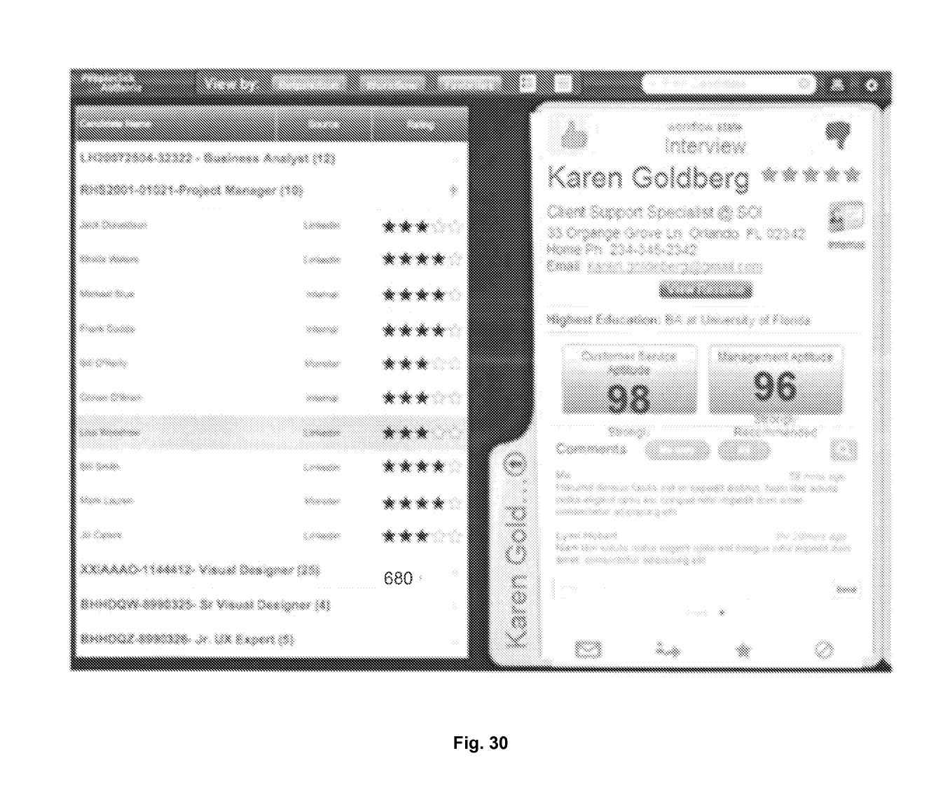

In panels 623 and 631, a workflow state is shown 632. Buttons 634 enables the manager to indicate a decision to hire, or to reject. The candidate's name 636, star-ranking 638, contact information 642, and the exposure level 640 are shown. The manager can touch a button 644 to view a formal resume. The highest education level 646 is shown, a list of comments 652 is displayed, and a text entry box 654 is provided. The candidates' aptitudes (in this case, for customer service and for management) are shown in boxes 648 and 650. The manager can also view the desired pay 656, more details about the education 658, and a work history 660. FIG. 30 shows the requisition display, this time in a list form 680.

Again, it is to be understood that the present examples are for the purpose of illustration only, and the details of a particular implementation are not meant to limit the present invention or the scope of this disclosure, which is appreciated for its general teachings by those skilled in the art.

Using a tablet computer to provide the applications to a manager has advantages relative to providing them on a desktop workstation. Data can be represented and manipulated in ways that provide a more intuitive and immersive experience. This will encourage use and facilitate the discovery of information that can have a meaningful impact on how to best leverage the talent in an organization. Mobile tablet type computing devices and similar processing smartphones and wireless communication devices are becoming more popular and have been adopted by many companies.

In some cases, similar applications can be provided in other versions for use on smart cell phones.

In some examples, the data that underlies the applications and is used in providing the information on the user interface include the following. Other kinds of information could also be used, for example:
The ID of the employee.
The name of the employee.
The ethnicity of the employee: Caucasian, Asian, Hispanic, etc.
The potential for this employee to leave the company: Extreme, High, Medium, Low.
The gender of the employee: Male, Female, Preferred Not to Answer, etc.
The impact that the leaving of this employee would have on the organization.
The employee's manager.
The combined rating of this employee.
The employee's title.
The type of position this employee maintains: Full Time, Part Time, Contract, Internship, etc.
The potential for this employee to succeed in the organization: High, Medium, Low.
The workforce segment that this employee is a part of: Strategic, Important, Key Skill Set, Tactical.
The pointer to the organization that the employee is a part of.
The ad hoc competency rating entered on the talent profile.
The ad hoc overall rating entered on the talent profile.
The business email of the user.
The CompA ratio of the employee.
The employee type: contractor, hourly, salaries, etc.
The date at which the employee started at their current position.
The companies assigned employee.
The first (given) name of the employee.
The data point for the high point of the employee's salary grade.
The data point for the mid point of the employee's salary grade.
The data point for the low point of the employee's salary grade.
Whether or not the employee has had global exposure.
The company assigned job code for the users position.
The description of this job.
The Family of this job: Executives, Administration, Finance, HR, Sales, Marketing, etc.
The functional family for this job: IT, Operations, Legal, Administrative/Clerical.
The Title of the job: CFO, General Counsel, Secretary, etc.
Data entered by the employee to describe their key accomplishments and professional development.
Data entered by the employee to highlight career strengths.
Last or Family name.
The level of management responsibility for this user: Individual Contributor, Manager, Director, Executive.
The processional groups that this person is a member of.
The middle name of the employee.
The duration of the employees global experience.
The home country of the employee.
The honors or awards that the employee has received.
The number of people on the talent pool for this employees position.
The number of people on this employees talent pool.
The number of slates this employee is slated on.
How soon before this employee should be promoted: Ready Now, Ready 6-12 mo., Ready 1 Year, Ready >1 Year.
The recommended percentile of market data that this employee should be leveled at.
If a retention policy for this employee is in place: In Development. In Place, None, etc.
The salary grade that this employee belongs to.
A bulleted list of skills that are important to this company that the employee has.
Skills that the employee has that are outside of the company.
Any special training that this employee has received pertaining to their position.
A list of languages that this employee speaks.
The employee's current employment status: Active, Inactive
Active or Inactive based on the employee status.
The goal rating filled in on the talent profile.
How well this employee fits their role: Emerging Leader, Correctly Places, Wrong Role, etc.
The amount of time this employee has been in this role: 6 months.
The amount of time this employee has been with the company: 1 Year 5 Months.
How willing the employee is to travel as part of their job: Agree, Disagree, Neutral, etc.
What percentage the employee is willing to travel as part of their job: 0-10%, 10-25%, etc.
In a new role, what percentage would an employee be willing to travel.
How willing is the employee to relocation: Agree, Disagree, Neutral, etc.
The number of years of relevant work experience the employee has.
The languages that the employee writes.
Market data for this position at the 25^{th} percentile.
Market data for this position at the 50^{th} percentile.
Market data for this position at the 75^{th} percentile.
Market data for this position at the 90^{th} percentile.
The identifier of the “owning” Employee.
The name of the school attended.
The type of school attended, for example, a two- or four-year college, university, trade school, or high school.
The degree earned.
The major in which the degree was earned.
The date attendance started.
The date attendance ended.
The year of graduation.
The grade point average across the attendance period.
The title for the position in which the candidate was employed.
The name of the company.
The First date of employment at the specified job.
The last date of employment at the specified job.
The description of the work performed in this position.
Plan year under which the benefit was paid.
Description of the benefit.
Amount of the benefit in local currency.
Currency in which the benefit is valued.
Date the bonus was paid.
Plan year under which the bonus was paid.
Description of the bonus award.
Amount of the bonus award in local currency.
Currency in which the bonus was paid.
Date the salary took effect.
Currency in which the salary is paid.
Rate of pay for the employee in local currency.
Amount of increase over the prior rate of pay in local currency.
Percentage increase over the prior rate of pay.
The reason for the salary increase.
Date the grant was issued.
Plan year under which the grant occurred.
Type of shares granted.
Number of shares granted.
Value of the grant at the time it was issued.
Currency in which the grant is valued.
The unique identified for the organization.
The organizations cost code.
A shorter name for the organization.
The full formal name for the organization.
An internal code for this organization/
The organizations type in the context of its hierarchy type: Company, Department, Division, Group, Location, Geographic Region, State, Country.
Physical city.
Physical country.
Physical postal code.
Physical region.
Mailing address city.
Mailing address country.
Mailing address postal code.
Mailing address region.
An organizations hierarchy type: geographic, primary
The unique identifier for the organization hierarchy relationship
The unique identifier for the organization.
An internal code of the organization.
The cost code for the organization.
The formal name for the organization.
A shorter name for the organization.
The unique identifier for the organization's parent organization.
An internal code name for the parent organization.
The cost code for the parent organization.
The formal name for the parent organization.
The type of hierarchy type for the parent organization: geographic, primary.
A shorter name for the parent organization.
The number of levels that the parent organization is above this organization.
The unique identifier for this position hierarchy relationship.
The Human Resource identifier for this position used to join the employee table.
The title for this position.
The name of the employee.
The number of levels that the parent position is above this current position.
The Human Resource record identifier for the parent position used to join the employee table.
The Title for the parent position.
The name of the parent.

Other implementations are also within the scope of the claims.

For example, the manager may be permitted to access and work with portions or all of organization charts for positions and people that he does not manage. For instance, a human resources manager may have permission to see and take actions with respect to any part of the organizational chart of an enterprise.

What is claimed is:

1. A computer-implemented method comprising:
in a user interface of an personnel management application, displaying a cloud of thumbnail images of personnel who are associated with respective values of a quantifiable management parameter; and
the thumbnail images having relative quantitative aspects that correspond to the respective values of the quantifiable management parameter with which they are respectively associated.

2. The method of claim 1 in which the quantifiable management parameter comprises monetary value associated with the personnel.

3. The method of claim 1, the quantifiable management parameter comprising a budget value associated with the personnel.

4. The method of claim 1, the quantifiable management parameter comprising a percentage of a budget value that has been spent.

5. The method of claim 1, the user interface being provided on a mobile computing device.

6. The method of claim 1, the user interface being provided on a tablet computer.

7. The method of claim 1, the quantitative aspect comprising a relative size of said thumbnail images.

8. The method of claim 1, said method implemented in a mobile computing device having a wireless communication feature, the method comprising presenting a plurality of said thumbnail images that correspond to personnel of a location of an organization and said method further comprising automatically updating the plurality of said presented thumbnail images based upon a geographic location of said mobile computing device.

9. A computer-implemented method comprising:
in a user interface, displaying a cloud of thumbnail images of personnel of an organization having a plurality of such personnel;
displaying the cloud of thumbnail images comprising displaying the thumbnails images associated with respective values of a quantifiable parameter; and
displaying said cloud of thumbnail images further comprising displaying relative sizes of said thumbnail images corresponding to values of the quantifiable parameter of the respective personnel with which the thumbnail images are associated.

10. The method of claim 9 in which each thumbnail image presented comprises a relative size corresponding to a relative budget size allocated to a subordinate person in a hierarchy of personnel under management.

11. The method of claim 10, further comprising a first filtering criterion affecting a set of the plurality of thumbnail images, the filtering criterion depending at least on one of: a geographic location, a type of employment, a potential, a performance rating, a flight risk, a position in an organizational structure, and a loss impact.

12. The method of claim 11, further comprising a second filtering criterion depending at least on one of: a geographic location, a type of employment, a potential, a performance rating, a flight risk, a position in an organizational structure, and a loss impact.

13. The method of claim 10 in which the user interface is presented to the user on a display of a mobile device.

14. The method of claim 10 in which the user interface is presented to the user on a display of a tablet computer.

15. A computer-implemented method comprising:
in a user interface, providing a visual navigational tool to enable a user to navigate through a set of candidates for employment to locate particular candidates one after another; and
automatically and simultaneously, as each of the particular candidates is located, displaying a folder of information concerning the candidate.

16. The method of claim 15 in which the visual navigational tool comprises images of stacks of folders associated with the candidates, and the user is enabled to navigate through the stacks and from stack of stack by gestural actions on a surface of a screen on which the user interface is presented.

17. The method of claim 16 in which the gestural actions comprise at least one of dragging, touching and swiping.

18. The method of claim 15 in which the user interface is presented to the user on a mobile device.

19. The method of claim 15 in which the user interface is presented to the user on a screen of a tablet computer.

20. A computer-implemented method comprising:
through a user interface of a mobile device, enabling a manager to navigate information about employees that he is managing;
updating the information in real time as the manager is navigating, at times when the mobile device can wirelessly communicate with a central server;
maintaining a body of the information on the mobile device that is sufficient for the manager to navigate when the mobile device cannot wirelessly communicate with the central server; and
updating the body of information when the mobile device can wirelessly communicate with the central server.

21. A mobile electronic device comprising:
a touch sensitive screen display;
an element that enables the device to determine its geographical location;
a wireless communication capability;
an operating system; and
an application configured to enable a manager of personnel to navigate information about the personnel, the information being determined at least in part automatically by a current geographical location determined by the element, and to synchronize the information automatically with a body of information at a central server so that, when the wireless communication capability is not available, the manager is able to navigate information about the personnel on the mobile electronic device.
